(19) United States
(12) Patent Application Publication
(10) Pub. No.: US 2019/0394267 A1
(43) Pub. Date: Dec. 26, 2019

(54) DYNAMIC VOTING NODES IN BLOCKCHAIN NETWORKS

(71) Applicant: Anami Holdings, Inc., Corona, CA (US)

(72) Inventor: Adam T. Bistram, Corona, CA (US)

(21) Appl. No.: 16/443,982

(22) Filed: Jun. 18, 2019

Related U.S. Application Data
(60) Provisional application No. 62/765,298, filed on Aug. 20, 2018.
(60) Provisional application No. 62/690,287, filed on Jun. 26, 2018.

(51) Int. Cl. H04L 29/08; H04L 9/06

(52) U.S. Cl. CPC H04L 67/1059; H04L 9/0643; H04L 2209/38; H04L 67/108; H04L 9/0637

(57) ABSTRACT

A blockchain network dynamically assigns voting nodes for faster transaction speed. A first group of nodes are determined to be used as voting nodes for a blockchain network. The first group of voting nodes are used to process transactions for the blockchain network. The determination may be made randomly, in a round-robin fashion, based on nodes that are least busy, based on nodes that are determined to be most reliable, and so on. At a point during operation of the blockchain network, a determination is made to re-determine voting nodes. A second group of nodes are determined to be used as the voting nodes for the blockchain network. The second group is then used to process transactions for the blockchain network.

### CROSS-REFERENCE TO RELATED APPLICATION(S)

This application is a nonprovisional patent application of and claims the benefit of U.S. Provisional Patent Application No. 62/765,298, filed Aug. 20, 2018 and titled “Dynamic Voting Nodes in Blockchain Networks,” and U.S. Provisional Patent Application No. 62/690,287, filed Jun. 26, 2018 and titled “Using Segments to Improve Access Speed in Blockchain Networks,” the disclosures of which are hereby incorporated herein by reference in their entireties.

### FIELD

The described embodiments relate generally to blockchain networks. More particularly, the present embodiments relate to blockchain networks that dynamically assign voting nodes for faster transaction speed.

### BACKGROUND

Blockchains are decentralized and distributed databases or digital ledgers that are used to record transactions across many computers. The blockchain includes a list of records, referred to as “blocks,” that may be linked and secured using cryptography. Each block may include a cryptographic hash of the previous block, a timestamp, and transaction data. The blockchain may be managed by a peer-to-peer network collectively adhering to a protocol for inter-node communication and validation of new blocks.

Each node in the network may store a complete copy of the entire blockchain. When a transaction is submitted, nodes of the network may come to a consensus according to the protocol regarding whether or not to validate the transaction. If so, the validated transaction may be added to the blockchain as a new block and propagated to storage throughout the network.

Once recorded, data in a block may be unable to be altered retroactively without alteration of all subsequent blocks, which may require collusion of a network majority. Thus, the decentralization and consensus may provide high fault tolerance and resistance to unauthorized modification. This may allow participants in the blockchain network to verify and audit transactions inexpensively and reliably.

### SUMMARY

The present disclosure relates to blockchain networks that dynamically assign voting nodes for faster transaction speed. A first group of nodes are determined to be used as voting nodes for a blockchain network. The first group of voting nodes are used to process transactions for the blockchain network. At a point during operation of the blockchain network, a determination is made to re-determine voting nodes. A second group of nodes are determined to be used as the voting nodes for the blockchain network. The second group is then used to process transactions for the blockchain network.

In various implementations, a system for dynamically assigning voting nodes to improve transaction speed in a blockchain network includes at least one non-transitory storage medium that stores instructions and at least one processor. The at least one processor executes the instructions to open a first segment for a blockchain, select a first voting node group from a set of peer nodes, use the first voting node group to process transactions for the first segment, open a second segment for the blockchain wherein the second segment is associated with a different portion of the blockchain than the first segment, select a second voting node group from the set of peer nodes, and use the second voting node group to process transactions for the second segment.

In some examples, the at least one processor selects the first voting node group randomly. In other examples, the at least one processor selects the first voting node group in a round-robin fashion. In still other examples, the at least one processor selects the first voting node group based on which of the set of peer nodes are least busy. In yet other examples, the at least one processor selects the first voting node group based on which of the set of peer nodes are most reliable. In some implementations of such examples, the at least one processor determines which of the set of peer nodes are most reliable by evaluating prior voting records in the blockchain.

In numerous examples, the at least one processor opens a third segment for the blockchain, selects a third voting node group from the set of peer nodes, and uses the third voting node group to process transactions for the third segment. The third segment may be associated with a different portion of the blockchain than the first segment and the second segment.

In some implementations, a system for dynamically assigning voting nodes to improve transaction speed in a blockchain network includes at least one non-transitory storage medium that stores instructions and at least one processor. The at least one processor executes the instructions to select a first voting node group from a set of peer nodes; use the first voting node group to process transactions for a blockchain; upon occurrence of an event, select a second voting node group from the set of peer nodes; and use the second voting node group to process transactions for the blockchain.

In various examples, a peer node is in both the first voting node group and the second voting node group. In other examples, the first voting node group and the second voting node group have no overlapping peer nodes.

In some examples, the event is creation of a new segment, elapse of a time period, or a transaction limit being reached. In numerous examples, the first voting node group has a same number of voting nodes as the second voting node group.

In various examples, the at least one processor selects the first voting node group by selecting a security leader node. In some cases of such examples, the at least one processor uses the security leader node to select voting nodes of a voting council.

In numerous implementations, an electronic device for dynamically assigning voting nodes to improve transaction speed in a blockchain network includes at least one non-transitory storage medium that stores instructions and at least one processor. The at least one processor executes the instructions to use a voting node group to process transactions for a segment of a blockchain; create a changed voting node group upon opening a new segment of the blockchain, the changed voting node group having a same number of nodes as the voting node group; and use the changed voting node group to process transactions for the new segment.

In various examples, the at least one processor creates the changed voting node group by submitting a test transaction to a set of nodes and selecting the changed voting node group from the set of nodes that respond fastest to the test transaction. In other examples, the at least one processor creates the changed voting node group by selecting the changed voting node group from a set of nodes that have the shortest network communication times. In still other examples, the at least one processor creates the changed voting node group by selecting the changed voting node group from a set of nodes that have the lowest resource loads. In yet other examples, the at least one processor creates the changed voting node group by excluding particular nodes. In additional examples, the at least one processor creates the changed voting node group by selecting nodes based on how the nodes processed prior transactions.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example of a blockchain network system.

FIG. 1B depicts an example of functional relationships between components of a node that may be used in the blockchain network system of FIG. 1A.

FIG. 2 depicts an example of a hyperledger fabric blockchain network system.

FIG. 3A depicts an example blockchain including a first segment created at a first time by a blockchain network, such as the blockchain network of FIG. 1A or the hyperledger fabric blockchain network of FIG. 2.

FIG. 3B depicts the blockchain of FIG. 3A after the blockchain network adds a first additional set of data and a branch to the first segment at a second time.

FIG. 3C depicts the blockchain of FIG. 3B after the blockchain network adds a second additional set of data to the first segment and creates a second segment at a third time.

FIG. 3D depicts the blockchain of FIG. 3C after the blockchain network archives the first segment and adds a third additional set of data and a branch to the second segment at a fourth time.

FIG. 3E depicts the blockchain of FIG. 3D after the blockchain network adds a fourth additional set of data to the second segment and creates a third segment at a fifth time.

FIG. 3F depicts the blockchain of FIG. 3E after the blockchain network archives the second segment and adds a fifth additional set of data to the third segment and creates a fourth segment at a fourth time.

FIGS. 4A and 4B depict a flow chart illustrating a first example method for using segments in a blockchain network. This method may be performed by the systems of FIGS. 1A or 2.

FIG. 5 depicts a flow chart illustrating an example method for searching in a blockchain network that uses segments. This method may be performed by the systems of FIGS. 1A or 2.

FIG. 6 depicts a flow chart illustrating a second example method for using segments in a blockchain network. This method may be performed by the systems of FIGS. 1A or 2.

FIG. 7 depicts a flow chart illustrating a third example method for using segments in a blockchain network. This method may be performed by the systems of FIGS. 1A or 2.

FIG. 8A depicts a first example of a blockchain network system that dynamically assigns voting nodes.

FIG. 8B depicts the system of FIG. 8A after a first group of peer nodes are assigned to be voting nodes.

FIG. 8C depicts the system of FIG. 8B after a second group of peer nodes are assigned to be voting nodes.

FIG. 9 depicts a flow chart illustrating a first example method for dynamically assigning voting nodes in a blockchain network. This method may be performed by the system of FIGS. 8A-8C.

FIG. 10 depicts a flow chart illustrating a second example method for dynamically assigning voting nodes in a blockchain network. This method may be performed by the system of FIGS. 8A-8C.

FIG. 11 depicts a flow chart illustrating a third example method for dynamically assigning voting nodes in a blockchain network. This method may be performed by the system of FIGS. 8A-8C.

FIG. 12 depicts a flow chart illustrating a fourth example method for dynamically assigning voting nodes in a blockchain network. This method may be performed by the system of FIGS. 8A-8C.

FIG. 13 depicts a flow chart illustrating a fifth example method for dynamically assigning voting nodes in a blockchain network. This method may be performed by the system of FIGS. 8A-8C.

FIG. 14 depicts a flow chart illustrating a sixth example method for dynamically assigning voting nodes in a blockchain network. This method may be performed by the system of FIGS. 8A-8C.

FIG. 15A depicts an example blockchain and a corresponding first segment with associated first assigned voting nodes created at a first time by a blockchain network that dynamically assigns voting nodes, such as the blockchain network of FIGS. 8A-8C.

FIG. 15B depicts the blockchain of FIG. 15A after the blockchain network created a second segment with different associated second assigned voting nodes at a second time.

FIG. 15C depicts the blockchain of FIG. 15B after the blockchain network created a third segment with different associated third assigned voting nodes at a third time.

FIG. 15D depicts the blockchain of FIG. 15C after the blockchain network created a fourth segment with different associated fourth assigned voting nodes at a fourth time.

FIG. 16A depicts a second example of a blockchain network system that dynamically assigns voting nodes.

FIG. 16B depicts the system of FIG. 16A after a security leader node is selected.

FIG. 16C depicts the system of FIG. 16B after the security leader node selects voting nodes.

FIG. 17 depicts a flow chart illustrating a seventh example method for dynamically assigning voting nodes in a blockchain network. This method may be performed by the system of FIGS. 16A-16C.

FIG. 18A depicts an example branched blockchain that may be created by multiple voting councils.

FIG. 18B depicts a first example of a reconciled version of the example branched blockchain of FIG. 18A that used a reconciliation node.

FIG. 18C depicts a second example of a reconciled version of the example branched blockchain of FIG. 18A that used a reconciliation voting council.

FIG. 18D depicts the example branched blockchain of FIG. 18A with superblocks indicated.

FIG. 18E depicts a third example of a reconciled version of the example branched blockchain of FIG. 18A that used superblock reconciliation.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Some blockchain networks have a group of nodes where a portion of the group is designated as voting nodes. The voting nodes may be the nodes that are used to process and approve transactions whereas other nodes perform functions other than processing transactions. For example, hyperledger fabric blockchain networks use voting nodes and read nodes. The voting nodes process transactions by arriving at a consensus and updating the blockchain. By contrast, read nodes may only store a copy of the blockchain.

Typically, blockchain networks that use voting nodes do not change the voting nodes during operation. The voting nodes are designated when the blockchain network is created and neither the nodes that perform this role nor the number of voting nodes ever change.

This may lead to delays in blockchain network operation. The time the voting nodes take to arrive at a consensus on transactions is the time the blockchain will spend processing transactions. When the blockchain network is first created, this amount of time may be small. This time may however grow to hours or more as the blockchain and/or the blockchain network grows. Processing, memory, or other resources of the voting nodes may become overloaded, network communication times between the voting nodes may increase, and/or other factors may increase the amount of time the voting nodes take to arrive at consensus when processing transactions.

Some blockchain networks may be able to accept long transaction times. For example, transaction times that increase to multiple hours may be acceptable in a thirty day escrow system. However, transaction times of even multiple minutes may be unacceptable in real time systems. For example, real time commercial transaction systems may be unworkable if the systems are not capable of responding quickly. Transaction times may need to be reduced in order to make blockchain networks feasible for various real time system applications.

The following disclosure relates to blockchain networks that dynamically assign voting nodes for faster transaction speed. A first group of nodes may be determined to be used as voting nodes for a blockchain network. The first group of voting nodes may be used to process transactions for the blockchain network. At a point during operation of the blockchain network, a determination may be made to re-determine voting nodes. A second group of nodes may be determined to be used as the voting nodes for the blockchain network. The second group may then be used to process transactions for the blockchain network.

In this way, faster transaction speed may be obtained. This may result from ameliorating issues that cause delays in the voting nodes to come to a consensus on transactions. As the voting nodes may be changed or reassigned during blockchain operation, transaction processing may not be delayed by slowed network communications to a particular voting node, overloaded resources of a particular voting node, and so on. Faster transaction speeds improve the operation of the devices in the blockchain network, resulting in a faster and more efficient blockchain network that can support real time commercial application requirements.

Additionally, dynamic reassignment of the voting nodes may improve the security and reliability of the blockchain network. When the voting nodes do not change, the blockchain network may be vulnerable to problems in those particular nodes. If the voting nodes change, there is less chance that a problem node will be one of the voting nodes. Further, if attackers cannot be certain which nodes are voting nodes, it will be more difficult for them to attack voting nodes. The anonymity inherent in this prevents attackers from being able to know which nodes to target, and minimizes their ability to exploit a voting node they do discover through the likelihood that the discovered voting node will not remain a voting node permanently.

In some embodiments, the voting nodes may be selected randomly. In other embodiments, the voting nodes may be assigned in a “round-robin” or other turn-based fashion. In yet other embodiments, the voting nodes may be selected from a group determined to be “least busy” (such as a group that has a least processor or memory load, a group that has a fastest network communication response time, a group that responds fastest to a test transaction, and so on). In still other embodiments, reliability of nodes may be evaluated and the voting nodes may be selected from a group determined to be the most reliable (such as based on past voting records, excluding particular nodes known to have problems, and so on).

In various embodiments, the same number of voting nodes may be selected each time that voting node selection is performed. In other embodiments, the number of voting nodes may change along with the nodes assigned to be voting nodes.

In some embodiments, previously selected voting nodes may again be selected as voting nodes. In other embodiments, a node's previous role as a voting node may disqualify that node from later selection.

Voting nodes may be re-determined at a variety of different times, such as upon the occurrence of an event. For example, the voting nodes may be re-determined when a time period (such as three months) elapses. By way of another example, the voting nodes may be re-determined when the transaction speed slows beyond a threshold (such as when a transaction time exceeds five minutes). In various implementations, the voting nodes may be re-determined upon the occurrence of any number of different events.

For example, a blockchain network may create or open a sequence of segments corresponding to different portions of a blockchain. The blockchain network may interact with a respective segment corresponding to the appropriate portion of the blockchain. In such an example, voting nodes may be selected for each segment. In some implementations of this example, the same number of voting nodes may be selected for each segment. Various configurations are possible and contemplated without departing from the scope of the present disclosure.

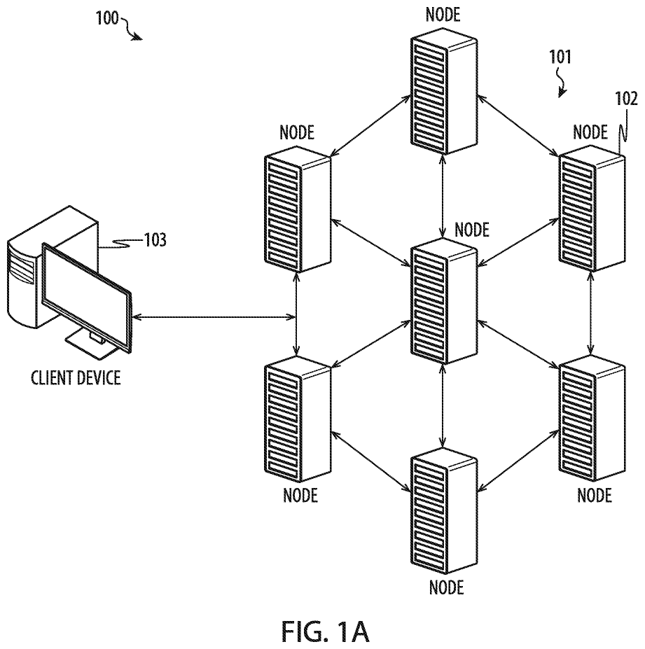

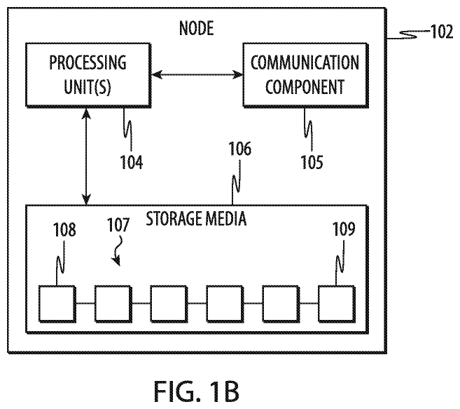

These and other embodiments are discussed below with reference to FIGS. 1A-18E. However, those skilled in the art will readily appreciate that the detailed description given herein with respect to these Figures is for explanatory purposes only and should not be construed as limiting.

FIG. 1A depicts an example of a blockchain network system 100. The system 100 may include a blockchain network 101 that has multiple nodes 102 configured in a peer-to-peer configuration. Each node 102 may store a copy of a blockchain. The nodes 102 may execute a software protocol for communicating with other nodes 102 in order to come to a consensus about validating new transactions, adding new validated transactions to the blockchain, and propagating the updated blockchain to the other nodes 102. The system 100 may be open, allowing any kind of computing device that can be configured to communicate using the appropriate protocol to be a node 102.

The system 100 may also include one or more client devices 103. The client device 103 may communicate with the system 100 in order to submit transactions, query the blockchain, and so on. The client device 103 may communicate with the system 100 as part of one or more digital currency applications, land title applications, escrow applications, banking applications, information storage applications, payment applications, invoicing applications, retailer system applications, and so on.

FIG. 1B depicts an example of functional relationships between components of a node 102 that may be used in the blockchain network system 100 of FIG. 1A. The node 102 may be any kind of computing device, such as a desktop computing device, a laptop computing device, a mobile computing device, a tablet computing device, a wearable device, a cellular telephone, a digital media player, and so on. The node 102 may include one or more processing units 104 or other processors or controllers, one or more communication components 105, one or more non-transitory storage media 106 (which may take the form of, but is not limited to, a magnetic storage medium; optical storage medium; magneto-optical storage medium; read only memory; random access memory; erasable programmable memory; flash memory; and so on), and so on. The processing unit 104 may execute instructions stored in the non-transitory storage medium 106 in order to perform one or more functions, such as communicating with other computing devices, validating transactions, searching for blocks, and so on.

A complete copy of a blockchain 107 may be stored in the non-transitory storage medium 106. The blockchain 107 may include a number of blocks, such as an initial or “genesis” block 108 and a most recent block 109.

Although the system 100 is illustrated and described as a particular configuration of a blockchain network system, it is understood that this is an example. Blockchain network systems may be configured in a variety of different arrangements.

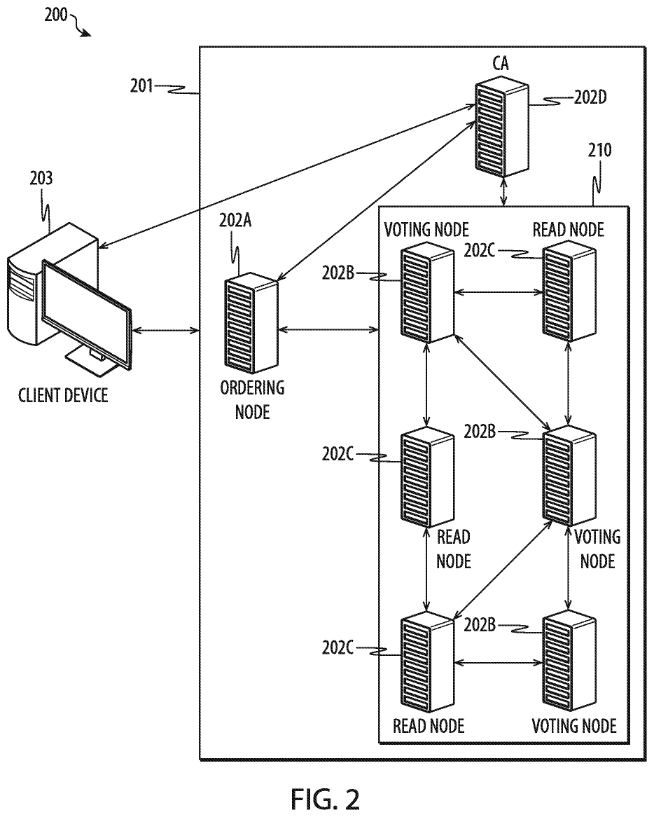

For example, FIG. 2 depicts an example of a hyperledger fabric blockchain network system 200. The hyperledger fabric blockchain network system 200 may include a hyperledger fabric blockchain network 201 and one or more client devices 203. The hyperledger fabric blockchain network 201 may include one or more ordering nodes 202A, a group of peer nodes 210 that include one or more voting nodes 202B and read nodes 202C, and one or more certificate authority devices 202D.

The group of peer nodes 210 may be directed by the ordering node 202A. For example, transactions received by the hyperledger fabric blockchain network 201 related to a blockchain may be directed by the ordering node 202A to the voting nodes 202B. The voting nodes 202B may come to a consensus about whether or not to validate the transaction in order to add the transaction to the blockchain according to the software protocol by which the hyperledger fabric blockchain network 201 operates. Voting nodes 202B may also store a copy of the blockchain and may be able to respond to requests to search and/or read blocks of the blockchain. Read nodes 202C may store a copy of the blockchain and be able to respond to requests to search and/or read blocks of the blockchain without any role in validating transactions.

Unlike the permission-less arrangement of the system 100 of FIG. 1A, device participation in the hyperledger fabric blockchain network 201 may be controlled. Devices may need to obtain a certificate or similar credential by communicating with the certificate authority device 202D in order to perform a role as an ordering node 202A, a voting node 202B, and/or a read node 202C.

Blockchain networks may use a variety of technologies to work with portions of the blockchain rather than the entirety. For example, the hyperledger fabric blockchain network 201 may use hyperledger channels. A hyperledger channel may function as a private “subnet” of communication between two or more members of the hyperledger fabric blockchain network 201. The channel may be identified by memberships, nodes of the group of peer nodes 210 that belong to those memberships, the shared portion of the blockchain corresponding to the channel (including the genesis block of the channel, regardless whether or not that block is the actual genesis block of the blockchain itself), chaincode application(s), and the ordering node(s) 202A. Transactions on the hyperledger fabric blockchain network 201 may be executed on the channel. If so, each member may need to be authenticated to transact on the channel. Each node of the group of peer nodes 210 that joins the channel may have its own identity given by a membership services provider. The membership services provider may authenticate each node that joins to its channel peers and services. Configuration information about the channel policies, memberships, and anchor peers may be stored, such as in the genesis block of the channel. Hyperledger channels may be used to provide segmented permissions to different portions of the blockchain and/or to different entities.

Another technology that may be used is to implement the blockchain as a number of segments. The segments may be separate, essentially functioning as separate chains. In some embodiments, the segments may be implemented using technologies similar to those used to implement channels. Each segment may form a different portion of the blockchain, though some segments may overlap. In this way, by forming a blockchain out of a number of segments rather than a single segment, individual segments may be searched rather than the entire blockchain. As blockchains are typically searched from a most recently added block backwards, being able to search from the most recent block of an individual segment rather than the most recent block of the entire blockchain may allow the search to skip searching a great deal of the blockchain in order to find the searched block.

When certain conditions occur, a branch may be created on a segment. A branch may mirror a portion of the most recent portion of the segment but additional sets of data added to the segment may not also be added to the branch. After the additional set of data is added to the segment, the branch may be used instead of the last block of the additional set of data to search the segment without searching back through the additional set of data. This may further improve search time.

As discussed herein, segments may also be used to improve blockchain access speed in the hyperledger fabric blockchain network 201 (or another blockchain network, such as the blockchain network 101 of FIG. 1A). When the blockchain is first created, the hyperledger fabric blockchain network 201 may create a segment for the blockchain and read and/or write to the blockchain using the segment. When various conditions occur, the hyperledger fabric blockchain network 201 may archive or close the segment and create a new segment. Thus, each segment may correspond to a portion of the blockchain of a certain time/date or a block number range. Time/date or block number may be part of the key used to search for a block. As such, the hyperledger fabric blockchain network 201 may use the time/date or the block number for a read and/or a write to select the segment where that time/date or block number may be found. The hyperledger fabric blockchain network 201 may then search using the selected segment. This may be faster than searching the entire blockchain, particularly as the size of the blockchain increases.

Further, when certain conditions occur, the hyperledger fabric blockchain network 201 may create a branch on a segment. The branch may mirror a portion of the most recent portion of the segment but the hyperledger fabric blockchain network 201 may not add additional sets of data added to the segment onto the branch. After the hyperledger fabric blockchain network 201 adds the additional set of data to the segment, the hyperledger fabric blockchain network 201 may use the branch instead of the last block of the additional set of data to search the segment. This may allow the hyperledger fabric blockchain network 201 to avoid searching back through the additional set of data and may further improve search time.

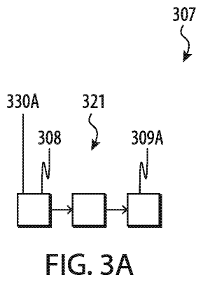

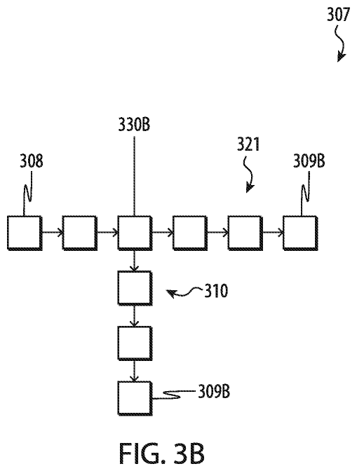

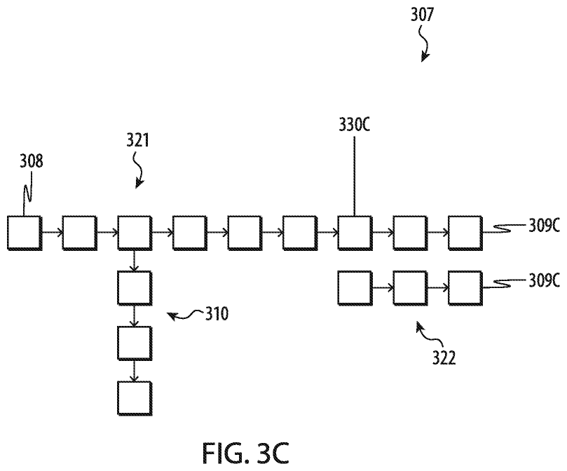

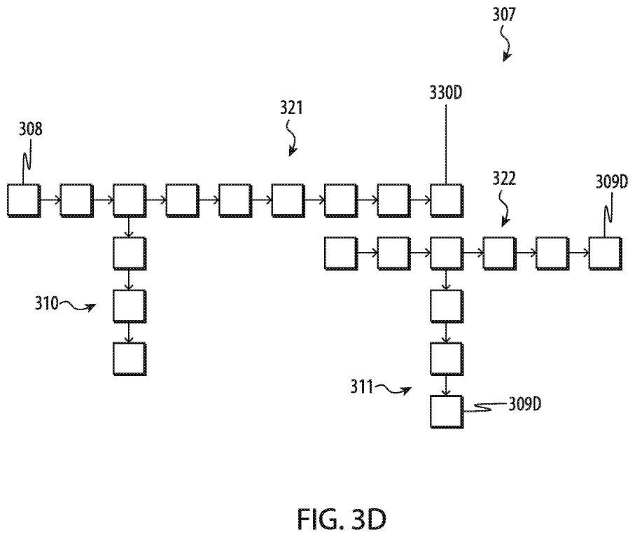

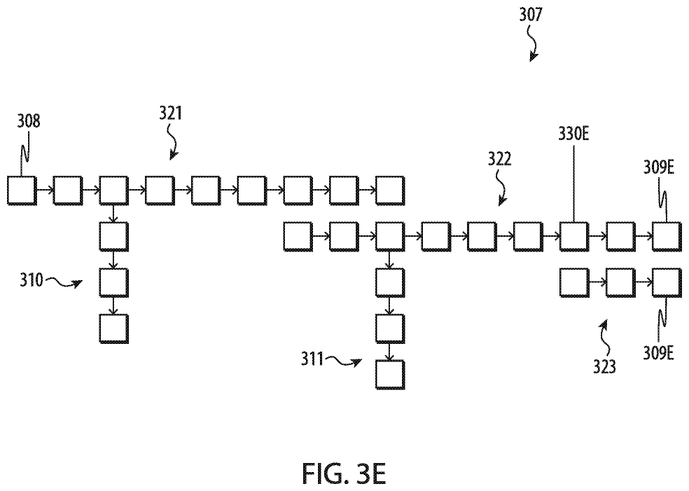

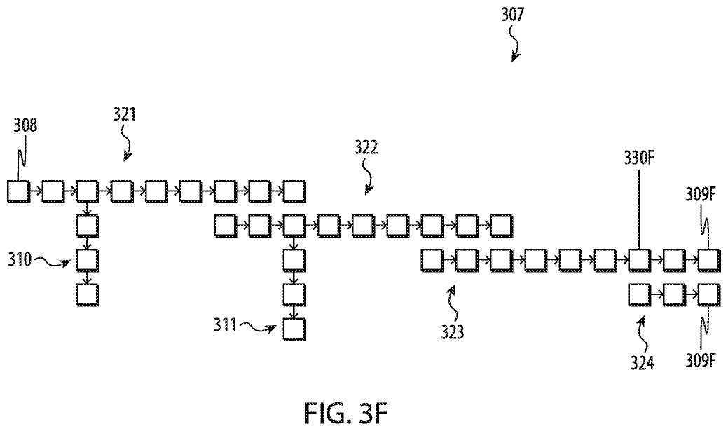

FIG. 3A depicts an example blockchain 307 including a first segment 321 created or opened at a first time 330A by a blockchain network, such as the blockchain network 101 of FIG. 1A or the hyperledger fabric blockchain network 201 of FIG. 2. As shown, the blockchain 307 includes a genesis block 308. The genesis block 308 is linked to a number of other blocks, terminating in a most recent block 309A. The blockchain network may read from and/or write to the blockchain 307 by reading from and/or writing to the first segment 321. The blockchain network may search the blockchain 307 by searching backwards from the most recent block 309A.

FIG. 3B depicts the blockchain of FIG. 3A after the blockchain network adds a first additional set of data and a branch 310 to the first segment 321 at a second time 330B. This creates a new most recent block 309B at the end of the first segment 321. The branch 310 mirrors the first additional set of data added to the first segment 321, also terminating in the most recent block 309B.

FIG. 3C depicts the blockchain of FIG. 3B after the blockchain network adds a second additional set of data to the first segment 321 and creates a second segment 322 at a third time 330C. This creates a new most recent block 309C at the end of the first segment 321 but not the branch 310. The second segment 322 includes the second additional set of data, also terminating in the most recent block 309C.

The first segment 321 corresponds to the entire blockchain 307 and the second segment 322 corresponds to the portion of the blockchain 307 from the third time 330C to the most recent block 309C. The blockchain network may search or access the entire blockchain 307 (or block numbers corresponding thereto) by searching or accessing the first segment 321. The blockchain network may search or access the portion of the blockchain 307 prior to the third time 330C by searching or accessing the branch 310. The blockchain network may search or access the portion of the blockchain 307 from the third time 330C to the most recent block 309C by searching or accessing the second segment 322.

FIG. 3D depicts the blockchain of FIG. 3C after the blockchain network archives or closes the first segment 321 and adds a third additional set of data and a branch 311 to the second segment 322 at a fourth time 330D. This creates a new most recent block 309D at the end of the second segment 322. The branch 311 mirrors the third additional set of data added to the second segment 322, also terminating in the most recent block 309D.

FIG. 3E depicts the blockchain of FIG. 3D after the blockchain network adds a fourth additional set of data to the second segment 322 and creates a third segment 323 at a fifth time 330E. This creates a new most recent block 309E at the end of the second segment 322 but not the branch 311. The third segment 323 includes the fourth additional set of data, also terminating in the most recent block 309E.

The second segment 322 corresponds to the portion of the blockchain 307 from the third time 330C to the most recent block 309E. The third segment 323 corresponds to the portion of the blockchain 307 from the fifth time 330E to the most recent block 309E. The blockchain network may search or access the portion of the blockchain 307 from the third time 330C to the most recent block 309E by searching or accessing the second segment 322. The blockchain network may search or access the portion of the blockchain 307 between the third time 330C to the fifth time 330E by searching or accessing the branch 311. The blockchain network may search or access the portion of the blockchain 307 from the fifth time 330E to the most recent block 309E by searching or accessing the third segment 323.

FIG. 3F depicts the blockchain of FIG. 3E after the blockchain network archives or closes the second segment 322 and adds a fifth additional set of data to the third segment 323 and creates or opens a fourth segment 324 at a sixth time 330F. This creates a new most recent block 309F at the end of the third segment 323. The fourth segment 324 includes the fifth additional set of data, also terminating in the most recent block 309F.

The third segment 323 corresponds to the portion of the blockchain 307 from the fifth time 330E to the most recent block 309F. The fourth segment 324 corresponds to the portion of the blockchain 307 from the sixth time 330F to the most recent block 309F. The blockchain network may search or access the portion of the blockchain 307 from the fifth time 330E to the most recent block 309F by searching or accessing the third segment 323. The blockchain network may search or access the portion of the blockchain from the sixth time 330F to the most recent block 309F by searching or accessing the fourth segment 324.

Thus, after the first three events that trigger (or the occurrence of the first three “triggering conditions”) creation of a new segment, there may always be at least one current segment, one previous segment, and at least one archive segment. Triggering events may include an elapse of a period of time (such as the time period between the first time 330A and the third time 330C, between the third time 330C and the fifth time 330E, or between the fifth time 330E and the sixth time 330F; which may be the same period of time or different periods of time), a size of the blockchain 307 and/or the segments 321-324 exceeding a threshold size (such as one gigabyte), a combination of these, and so on.

As shown, no branch is added to the third segment 323. In this example, branches may not be added to all segments. Branches may be added based on a variety of different conditions. Such conditions may include expiration of a different time period from creation or opening of a new segment, size of a segment reaching a size threshold (such as five hundred megabytes), and so on. Various configurations are possible and contemplated without departing from the scope of the present disclosure.

From the state of the blockchain 307 and the segments 321-324 shown in FIG. 3F, the blockchain network may select one of the segments 321-324 or the branches 310, 311 when searching for blocks of the blockchain 307 based on a date, time, or block number within a range associated with one or more of the segments 321-324 or the branches 310, 311. Due to the fewer number of blocks that may be searched in this way compared to the entire blockchain 307, this may improve search time. As such, the efficiency and resource consumption may be improved.

As shown and described above, the segments 321-324 may overlap with each other. For example, the second segment 322 overlaps with the first segment 321 (its previous segment) and the third segment 323 (its subsequent segment). This may ensure that links between blocks are not cut off between segments 321-324. This may also allow for different ranges of times/dates or block numbers to be searched without having to use multiple segments 321-324. This may also ensure that data related to transactions are not cut off between segments, which could result in the inability to access or use the data. However, it is understood that this is an example. In various implementations, segments may not overlap.

Further, the overlapping is shown and described as having a gap between the first segment 321 and the third segment 323 and between the second segment 322 and the fourth segment 324. However, it is understood that this is an example. In some implementations, a segment may be archived or closed when the second subsequent segment is created or opened in order to ensure greater data redundancy. In such a case, the blockchain 307 could be represented entirely by the first segment 321 and the third segment 323 even if the second segment 322 and the fourth segment 324 were removed. Various configurations are possible and contemplated without departing from the scope of the present disclosure.

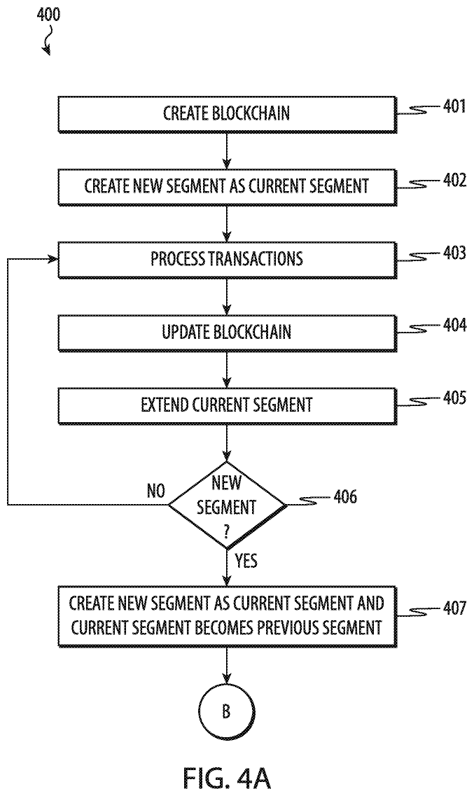

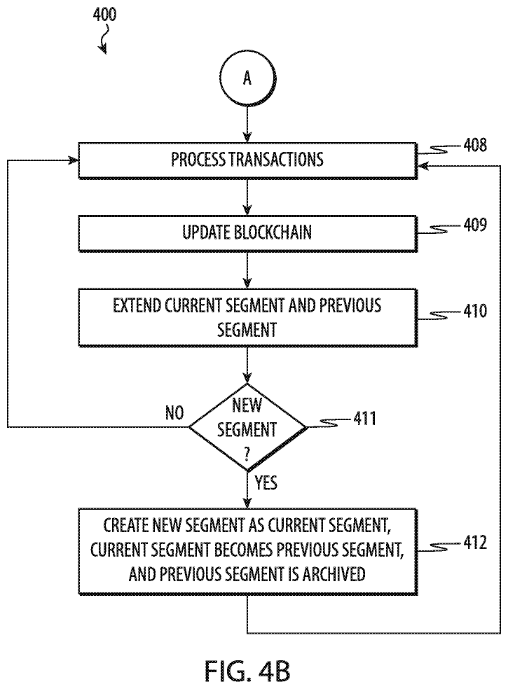

FIGS. 4A and 4B depict a flow chart illustrating a first example method 400 for using segments in a blockchain network. This method 400 may be performed by the systems 100, 200 of FIGS. 1A or 2.

The flow begins at 401 where a blockchain network is created. The flow then proceeds to 402 where a new segment is created as a current segment. Next, the flow proceeds to 403 where transactions are processed. The flow then proceeds to 404 where the blockchain is updated for the processed transactions. Next, the flow proceeds to 405 where the current segment is extended based on the updated blockchain and the processed transactions.

Although the method 400 is illustrated and described as updating the blockchain and extending the current segment based on the processed transactions sequentially at 404 and 405, it is understood that this is an example. Updating the blockchain and extending the segment may be part of the same operation rather than separate operations.

From 405, the flow proceeds to 406 where it is determined whether or not to create a new segment. If so, the flow proceeds to 407. Otherwise, the flow returns to 403 where additional transactions are processed.

At 407, after it is determined to create a new segment, a new segment is created as the current segment and the previously current segment becomes the previous segment.

The flow then proceeds to 408 where transactions are processed. The flow then proceeds to 409 where the blockchain is updated for the processed transactions. Next, the flow proceeds to 410 where the current segment and the previous segment are extended based on the updated blockchain and the processed transactions.

The flow proceeds to 411 where it is determined whether or not to create a new segment. If so, the flow proceeds to 412. Otherwise, the flow returns to 408 where additional transactions are processed.

At 412, after it is determined to create a new segment, a new segment is created as the current segment, the previously current segment becomes the previous segment, and the previously previous segment is archived or closed. The flow then returns to 408 where additional transactions are processed.

Although the example method 400 is illustrated and described as including particular operations performed in a particular order, it is understood that this is an example. In various implementations, various orders of the same, similar, and/or different operations may be performed without departing from the scope of the present disclosure.

For example, in some implementations, operations 404 and 405 and/or 409 and 410 may be different aspects of the same action rather than separate operations. Various configurations are possible and contemplated.

By way of another example, the method 400 illustrates and describes creating or opening new segments but does not involve adding branches to segments. However, in various implementations, determinations may be made regarding whether or not to add one or more branches to one or more segments. Such a determination may be made based on the expiration of one or more time periods, sizes of segments, and so on. Various configurations are possible and contemplated.

The determination to create a new segment at 406 and/or 411 may be performed according to a variety of different criteria. In various implementations, new segments may be created at 406 and/or 411 if one or more time periods have elapsed. In some examples, the time periods may be uniform. In other examples, the time periods may have different durations.

In other implementations, new segments may be created at 406 and/or 411 if the size of a current or previous segment or the blockchain itself exceeds a size threshold. In still other implementations, new segments may be created at 406 and/or 411 if the size of a current or previous segment or the blockchain itself is determined to exceed a size threshold after one or more time periods have elapsed. Various configurations are possible and contemplated.

In various examples, this example method 400 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

For example, in one embodiment, a system for using segments to improve access speed in a blockchain network includes at least one non-transitory storage medium that stores instructions and at least one processor. The at least one processor executes the instructions to create a first segment for a blockchain; upon occurrence of a triggering condition, create a second segment for the blockchain, the second segment associated with a different portion of the blockchain than the first segment; receive a search query for the blockchain that is associated with a date or a block number; and select the first segment or the second segment to search using the date or the block number of the search query.

In some examples, the triggering condition is expiration of a time period. In various implementations of such an example, the time period is approximately three months. In other examples, the triggering condition is a size of the first segment exceeding a size threshold. In some implementations of such an example, the at least one processor checks if the size of the first segment exceeds the size threshold upon expiration of a time period.

In various examples, upon occurrence of an additional triggering condition, the at least one processor creates a third segment for the blockchain that is associated with a first portion of the blockchain that is associated with the first segment and a second portion of the blockchain that is associated with the second segment. In some examples, upon occurrence of an additional triggering condition, the at least one processor adds a branch to the first segment prior to adding a set of data to the first segment. The at least one processor may be operable to search the first segment prior to the set of data using the branch.

By way of another example, in another embodiment, a system for using segments to improve access speed in a blockchain network may include at least one non-transitory storage medium that stores instructions and at least one processor. The at least one processor executes the instructions to create a first segment associated with a first portion of a blockchain; at a first time, create a second segment associated with a second portion of the blockchain that is subsequent to the first time; at a second time, create a third segment associated with a third portion of the blockchain that is subsequent to the second time; close the first segment so the first portion of the blockchain is previous to the second time; receive a query for a block of the blockchain; and select the first segment, the second segment, or the third segment to search for the block using data specified in the query.

In various examples, the first segment overlaps the second segment and the second segment overlaps the third segment. In some examples, the at least one processor creates a fourth segment associated with a fourth portion of the blockchain at a fourth time and closes the second segment so the second portion of the blockchain is previous to the fourth time.

In numerous examples, the first time is a first period of time after the first segment is created and the second time is a second period of time after the first time. In various implementations of such examples, the first period of time is equal to the second period of time. In other implementations of such examples, the first period of time and the second period of time have different durations.

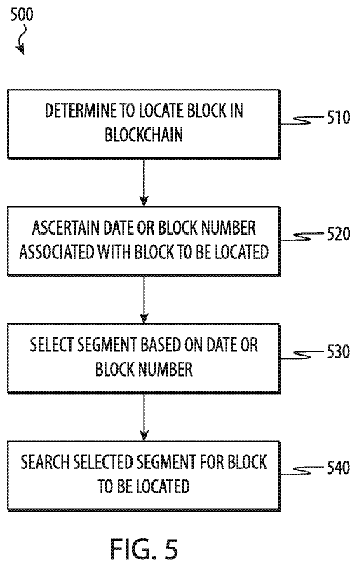

FIG. 5 depicts a flow chart illustrating an example method 500 for searching in a blockchain network that uses segments. This method 500 may be performed by the systems 100, 200 of FIGS. 1A or 2. This method 500 may be performed using a set of multiple segments that correspond to a time/date or block number range portion of a blockchain, such as the blockchains and corresponding segments detailed above with respect to FIGS. 3A-3F and 4A-4B.

The flow begins at 501 where it is determined to locate a block in a blockchain. It may be determined to locate the block in order to read the data of the block, to write data to the block, and so on. The flow then proceeds to 520 where a date and/or time or block number associated with the block to be located is ascertained. Next, the flow proceeds to 530 where a segment is selected based on the date, time, and/or block number. The flow then proceeds to 540 where the selected segment is searched for the block to be located.

Although the example method 500 is illustrated and described as including particular operations performed in a particular order, it is understood that this is an example. In various implementations, various orders of the same, similar, and/or different operations may be performed without departing from the scope of the present disclosure.

For example, the method is illustrated and described at 530 as selecting the segment based on the date, time, and/or block number. In some implementations, more than one segment may be selectable based on the date, time, and/or block number. For example, in implementations like those detailed above with respect to FIGS. 3A-3F and 4A-4B, segments may overlap and either of the overlapping segments may be selected. In such implementations, various data may be evaluated to determine which of the overlapping segments to select.

For example, if the date, time, and/or block number would be found in either and the overlapping segments have different sizes, the smaller of the two segments may be selected. By way of another example, if a block is part of a block sequence that is to be searched for, the segment that will contain more of the range of block sequence may be selected. Various configurations are possible and contemplated without departing from the scope of the present disclosure.

By way of another example, the method 500 illustrates and describes selecting among segments but does not involve considering branches of segments. However, in various implementations, one or more branches of a segment may be selected instead of the segment itself. Various configurations are possible and contemplated.

In various examples, this example method 500 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

For example, in one embodiment, a system for using segments to improve access speed in a blockchain network may include at least one non-transitory storage medium and at least one processor. The non-transitory storage medium may store instructions and a group of segments that each correspond to different portions of a blockchain. The at least one processor may execute the instructions to receive a query to search for a block of the blockchain, select a segment of the group of segments using a date or a block number corresponding to the query, and search the segment of the group of segments for the block.

In some examples, the group of segments correspond to all of the blockchain. In various examples, the group of segments overlap each other.

In numerous examples, the different portions all have a same duration. In various examples, the different portions all have a same size.

In some examples, at least one of the group of segments is an archive segment. In various examples, the query is a read query or a write query.

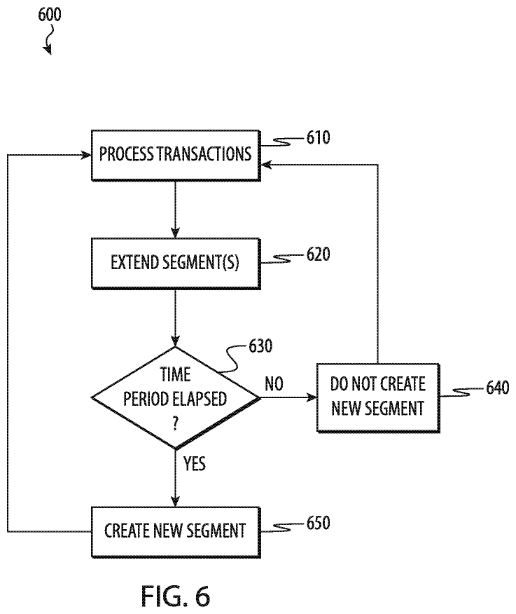

FIG. 6 depicts a flow chart illustrating a second example method 600 for using segments in a blockchain network. This method 600 may be performed by the systems 100, 200 of FIGS. 1A or 2.

At 610, transactions are processed. The flow then proceeds to 620 where one or more segments are extended and a corresponding blockchain is updated for the processed transactions. Next, the flow proceeds to 630 where it is determined whether or not a time period is elapsed. For example, the time period may be three months. If the time period has not elapsed, the flow proceeds to 640 where it is determined to not create a new segment before the flow returns to 610 and additional transactions are processed. Otherwise, the flow proceeds to 650 where a new segment is created before the flow returns to 610 and additional transactions are processed.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as creating a new segment at 650. In various implementations, 650 may also involve changing the status of an existing segment from current to previous, from previous to archived, and so on. Various configurations are possible and contemplated without departing from the scope of the present disclosure.

By way of another example, the method 600 illustrates and describes creating or opening new segments but does not involve adding branches to segments. However, in various implementations, one or more branches may be added to one or more segments. Various configurations are possible and contemplated.

In various examples, this example method 600 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

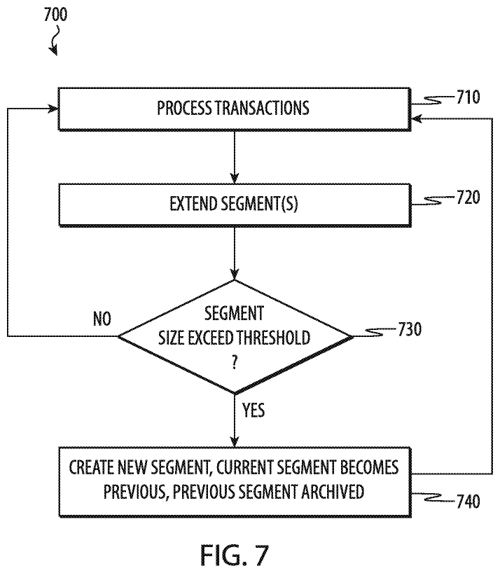

FIG. 7 depicts a flow chart illustrating a third example method 700 for using segments in a blockchain network. This method 700 may be performed by the systems 100, 200 of FIGS. 1A or 2.

At 710, transactions are processed. The flow then proceeds to 720 where one or more segments are extended and a corresponding blockchain is updated for the processed transactions. Next, the flow proceeds to 730 where it is determined whether or not the size of the one or more segments exceeds a threshold. For example, the threshold may be 300 megabytes. If so, the flow proceeds to 740 where a new segment is created before the flow returns to 710 and additional transactions are processed. Otherwise, the flow returns to 710 and additional transactions are processed.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as evaluating whether or not the segment size exceeds the threshold at 730. However, in various implementations, the size of the segment may be evaluated to see if it exceeds the threshold upon the elapse of a time period, such as one week. Various configurations are possible and contemplated without departing from the scope of the present disclosure.

In various examples, this example method 700 may be implemented as a group of interrelated software modules or components that perform various functions discussed herein. These software modules or components may be executed by one or more computing devices, such as one or more of the node 102 of FIGS. 1A-1B or the ordering node 202A, the voting node 202B, and/or the read node 202C of FIG. 2.

As discussed above, blockchain networks that use voting nodes typically do not change the voting nodes during operation. The voting nodes are designated when the blockchain network is created and neither the nodes that perform this role nor the number of voting nodes ever change. This may lead to delays in blockchain network operation.

However, the present disclosure relates to blockchain networks that dynamically assign voting nodes for faster transaction speed. A first group of nodes may be determined to be used as voting nodes for a blockchain network. The first group of voting nodes may be used to process transactions for the blockchain network. At a point during operation of the blockchain network, a determination may be made to re-determine voting nodes. A second group of nodes may be determined to be used as the voting nodes for the blockchain network. The second group may then be used to process transactions for the blockchain network. In this way, faster transaction speed may be obtained. This may result from ameliorating issues that cause delays in the voting nodes to come to a consensus on transactions. As the voting nodes may be changed or reassigned during blockchain operation, transaction processing may not be delayed by slowed network communications to a particular voting node, overloaded resources of a particular voting node, and so on. Faster transaction speeds may improve the operation of the devices in the blockchain network, resulting in a faster and more efficient blockchain network that can support real time commercial application requirements.

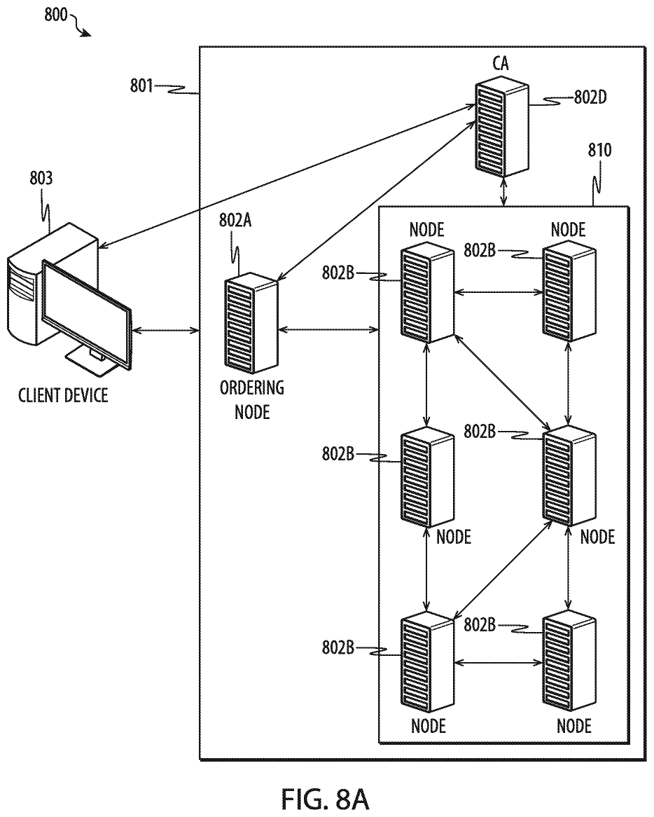

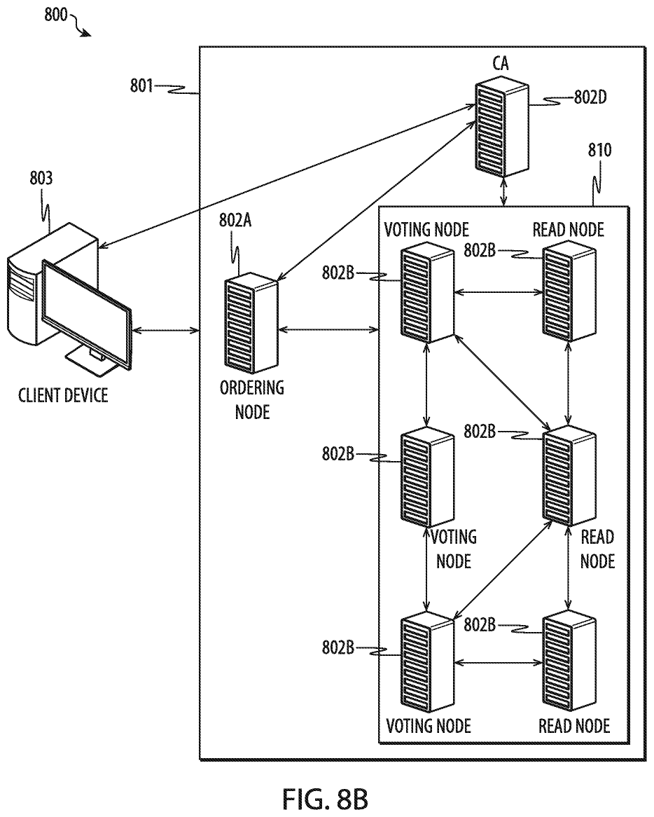

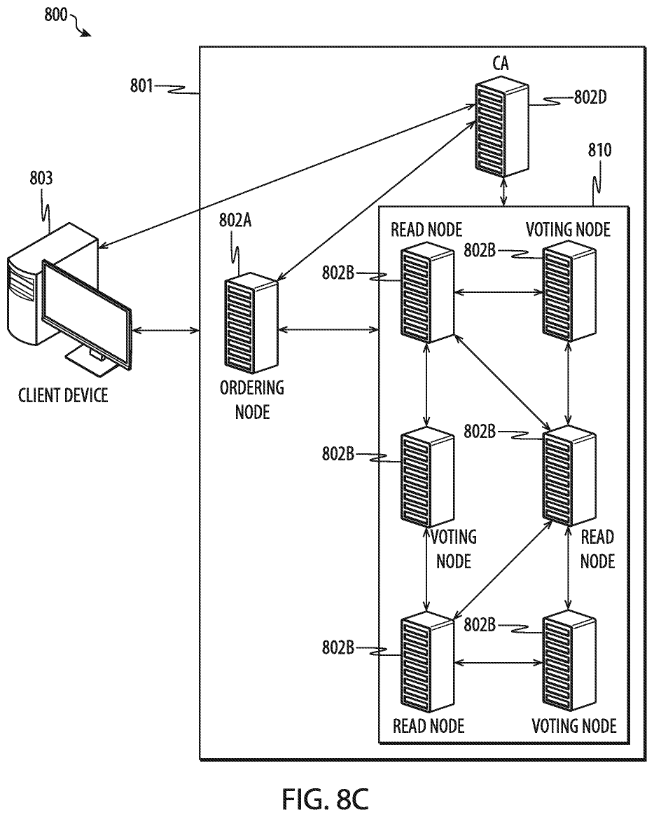

For example, FIG. 8A depicts an example of a blockchain network system 800 that dynamically assigns voting nodes. The blockchain network system 800 may be a hyperledger fabric blockchain network system. The blockchain network system 800 may include a hyperledger fabric blockchain network 801 and one or more client devices 803. The hyperledger fabric blockchain network 801 may include one or more ordering nodes 802A, a group 810 of peer nodes 802B, and one or more certificate authority devices 802D.

The peer nodes 802B may each be able to operate as either voting nodes or read nodes at a particular time. The hyperledger fabric blockchain network 801 (such as the ordering node 802A) may dynamically assign each of the peer nodes 802B to be a voting node or a read node. Subsequently, the hyperledger fabric blockchain network 801 may reassign the peer nodes 802B, changing whether the peer nodes 802B function as a voting node or a read node. The hyperledger fabric blockchain network 801 may reassign voting nodes any number of different times during operation.

For example, the hyperledger fabric blockchain network 801 may determine to use a first group of peer nodes 802B as voting nodes. These determined peer nodes 802B may then be used to process transactions for the hyperledger fabric blockchain network 801. FIG. 8B depicts the system 800 of FIG. 8A after a first group of peer nodes 802B are assigned to be voting nodes.

Subsequently, the hyperledger fabric blockchain network 801 may re-determine voting nodes. The hyperledger fabric blockchain network 801 may determine a second group of peer nodes 802B as the voting nodes. This second group of determined peer nodes 802B may then be used to process transactions. FIG. 8C depicts the system 800 of FIG. 8B after a second group of nodes are assigned to be voting nodes.

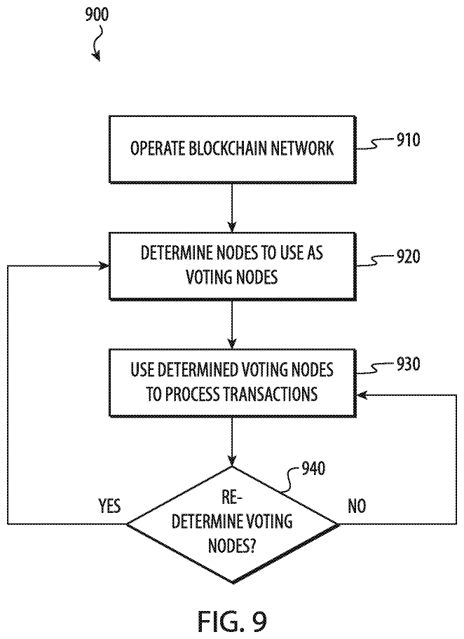

FIG. 9 depicts a flow chart illustrating a first example method 900 for dynamically assigning voting nodes in a blockchain network. This method 900 may be performed by the system 800 of FIGS. 8A-8C.

At 910, a blockchain network is operated. The flow then proceeds to 920 where nodes to use as voting nodes are determined. The voting nodes may be determined in a variety of different ways. Next, the flow proceeds to 930 where the determined voting nodes are used to process transactions for the blockchain network.

The flow then proceeds to 940 where it is determined whether or not to re-determine voting nodes. The determination of whether or not to re-determine voting nodes may be dependent upon a variety of different factors, such as upon the occurrence of an event. For example, the voting nodes may be re-determined when a time period (such as three months) elapses. By way of another example, the voting nodes may be re-determined when the transaction speed slows beyond a threshold (such as when a transaction time exceeds five minutes). In various implementations, the voting nodes may be re-determined upon the occurrence of any number of different events.

If is determined to re-determine voting nodes, the flow returns to 920 where the voting nodes are re-determined. Otherwise, the flow returns to 930 where the current voting nodes are used to process additional transactions for the blockchain network.

Although the example method 900 is illustrated and described as including particular operations performed in a particular order, it is understood that this is an example. In various implementations, various orders of the same, similar, and/or different operations may be performed without departing from the scope of the present disclosure.

For example, the example method 900 is illustrated and described as using determined voting nodes to process transactions for the blockchain network prior to determining whether or not to re-determine voting nodes. However, in some examples, it may be determined whether or not to re-determine voting nodes prior to using previously determined voting nodes to process any transactions for the blockchain network. Various procedures are possible and contemplated without departing from the scope of the present disclosure.

In various examples, this example method 900 may be implemented as a group of interrelated software modules or components that perform various functions discussed herein. These software modules or components may be executed by one or more computing devices, such as one or more of the ordering node 802A or the peer nodes 802B of FIG. 8A.

In various embodiments, the same number of voting nodes may be selected each time that voting node selection is performed. In other embodiments, the number of voting nodes may change along with the nodes assigned to be voting nodes. In some embodiments, previously selected voting nodes may again be selected as voting nodes. In other embodiments, a node's previous role as a voting node may disqualify that node from later selection. Various implementations are possible and contemplated without departing from the scope of the present disclosure.

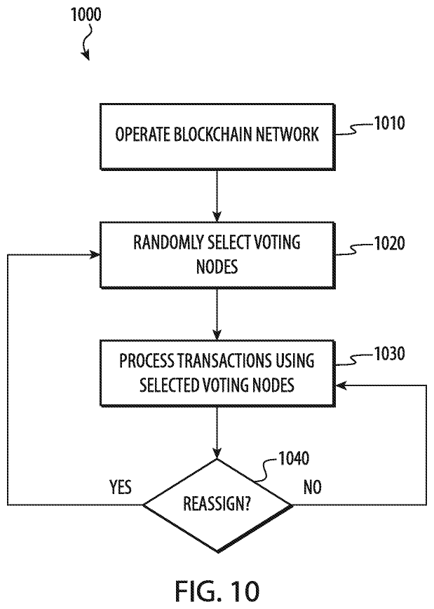

The voting nodes may be determined in a variety of different ways. In some embodiments, the voting nodes may be selected randomly. For example, FIG. 10 depicts a flow chart illustrating a second example method 1000 for dynamically assigning voting nodes in a blockchain network. This method 1000 may be performed by the system 800 of FIGS. 8A-8C.

At 1010, a blockchain network operates. The flow then proceeds to 1020 where voting nodes are randomly selected. Next, the flow proceeds to 1030 where the selected voting nodes are used to process transactions for the blockchain network.

The flow then proceeds to 1040 where it is determined whether or not to reassign voting nodes. If so, the flow returns to 1020 where randomly selected nodes are reassigned to be voting nodes. Otherwise, the flow returns to 1030 where the previously selected voting nodes are used to process transactions for the blockchain network.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as “randomly” selecting voting nodes. However, computing devices may be unable to generate truly random numbers. Computing devices may instead generate numbers that appear random (e.g., pseudorandom numbers) using procedures that involve a sufficient number of variables that the result is not easily predictable. As such, in various implementations, the term “random” may include such pseudorandom determination procedures without departing from the scope of the present disclosure.

In various examples, this example method 1000 may be implemented as a group of interrelated software modules or components that perform various functions discussed herein. These software modules or components may be executed by one or more computing devices, such as one or more of the ordering node 802A or the peer nodes 802B of FIG. 8A.

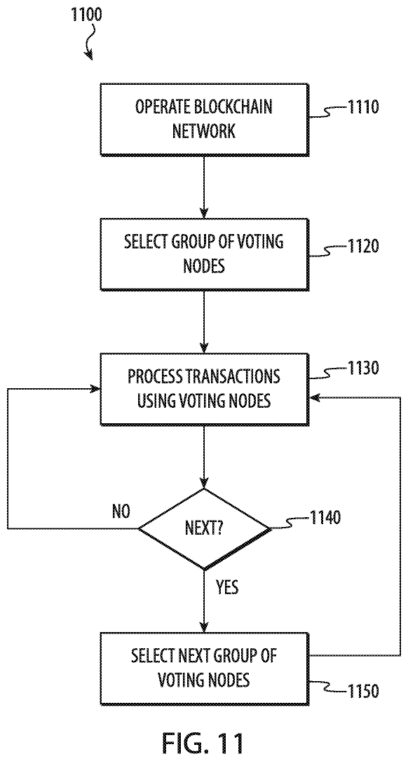

In other embodiments, the voting nodes may be assigned in a “round-robin” or other turn-based fashion. For example, FIG. 11 depicts a flow chart illustrating a third example method 1100 for dynamically assigning voting nodes in a blockchain network. This method 1100 may be performed by the system 800 of FIGS. 8A-8C.

At 1110, a blockchain network may be operated. The flow then proceeds to 1120 where a group of voting nodes (or voting node group) may be selected. For example, a list of available nodes may be maintained and the group of voting nodes may be selected as the first available nodes on the list. The list may then be updated to remove those nodes and/or move those nodes to the end of the list. Next, the flow proceeds to 1130 where transactions for the blockchain may be processed using the selected voting nodes.

The flow may then proceed to 1140 where it is determined whether or not to select a next group of nodes. If so, the flow proceeds to 1150 where the next group of voting nodes (or next voting node group) is selected before the flow returns to 1130 and the newly selected voting nodes are used to process transactions for the blockchain network. For example, the group of voting nodes may be selected as the next first available nodes on the list and the list may then be updated to remove those nodes and/or move those nodes to the end of the list. Otherwise, the flow returns to 1130 and the previously selected voting nodes are used to process transactions for the blockchain network.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 is described as using a list of available nodes. However, in various implementations, nodes may indicate their availability to serve as voting nodes and voting nodes may be selected from a group of nodes that have recently indicated their availability. Various configurations are possible and contemplated without departing from the scope of the present disclosure.

In various examples, this example method 1100 may be implemented as a group of interrelated software modules or components that perform various functions discussed herein. These software modules or components may be executed by one or more computing devices, such as one or more of the ordering node 802A or the peer nodes 802B of FIG. 8A.

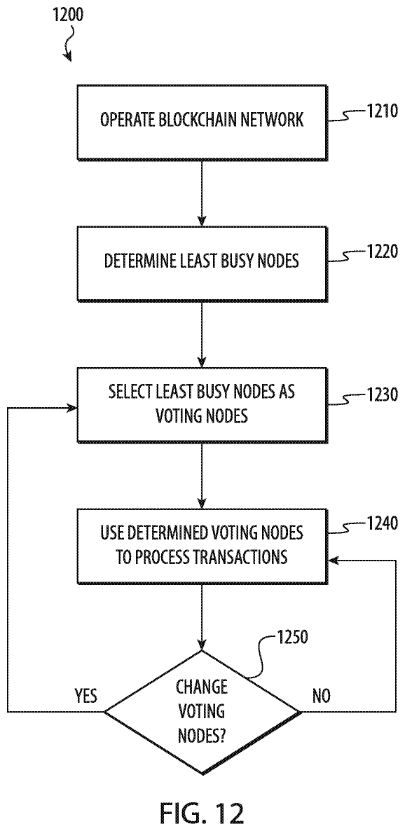

In yet other embodiments, the voting nodes may be selected from a group determined to be “least busy” (such as a group that has a least processor or memory load, a group that has a fastest network communication response time, a group that responds fastest to a test transaction, and so on). For example, FIG. 12 depicts a flow chart illustrating a fourth example method 1200 for dynamically assigning voting nodes in a blockchain network. This method 1200 may be performed by the system 800 of FIGS. 8A-8C.

At 1210, a blockchain network may be operated. The flow then proceeds to 1220 where least busy nodes may be determined. Least busy nodes may be determined in a variety of different ways. For example, resource loads (such as processor utilization, memory utilization, available processor time, available memory, and so on) of each of the nodes may be monitored and the nodes that have the lowest recourse loads may be determined to be the least busy nodes. By way of another example, network communication times with the nodes may be monitored and evaluated (such as the response time to a network ping) and the nodes with the shortest network communication times may be determined to be the least busy nodes. In another example, nodes may be sent one or more test transactions to process and the nodes that process the test transaction the fastest may be determined to be the least busy nodes. In yet other examples, various combinations of these and/or other criteria may be used to determine which are the least busy nodes. Various procedures are possible and contemplated without departing from the scope of the present disclosure.

Next, the flow proceeds to 1230 where the least busy nodes are selected as the voting nodes. The flow then proceeds to 1240 where the determined voting nodes are used to process transactions for the blockchain network.

Subsequently, the flow proceeds to 1250 where it is determined whether or not to change voting nodes. If so, the flow returns to 1230 where the currently determined least busy nodes are selected as the voting nodes. Otherwise, the flow returns to 1240 where the previously determined least busy nodes are used as the voting nodes to process transactions for the blockchain network.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 is illustrated and described as returning to 1230 upon determining to change voting nodes. However, in some examples, the flow may instead return to 1220 where the least busy nodes are determined. Various configurations are possible and contemplated without departing from the scope of the present disclosure.

In various examples, this example method 1200 may be implemented as a group of interrelated software modules or components that perform various functions discussed herein. These software modules or components may be executed by one or more computing devices, such as one or more of the ordering node 802A or the peer nodes 802B of FIG. 8A.

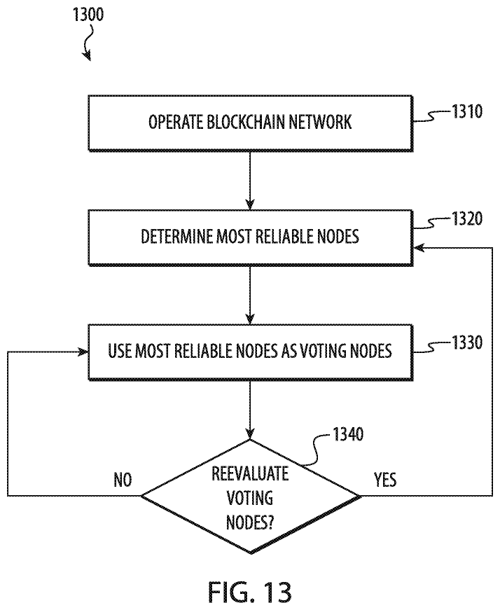

In still other embodiments, reliability of nodes may be evaluated and the voting nodes may be selected from a group determined to be the most reliable (such as based on past voting records, excluding particular nodes known to have problems, and so on). For example, FIG. 13 depicts a flow chart illustrating a fifth example method 1300 for dynamically assigning voting nodes in a blockchain network. This method 1300 may be performed by the system 800 of FIGS. 8A-8C.

At 1310, a blockchain network may be operated. The flow then proceeds to 1320 where the most reliable nodes may be determined. The most reliable nodes may be determined in a variety of different ways.

For example, blocks in the blockchain may store identifiers for each voting node that voted as part of processing the transaction for the block. The blocks may also store how each voting node voted on the transaction. In such an example, the blocks in the blockchain may be evaluated to determine past voting records for nodes. Nodes that previously voted to approve transactions that were approved may be assigned points or other indicators towards a score that indicates reliability of the node. Similarly, nodes that previously voted to deny transactions that were denied may be assigned points or other indicators towards a score that indicates reliability of the node. Conversely, nodes that previously voted to approve transactions that were denied or to deny transactions that were approved may be assigned points or other indicators towards a score that indicates that the node is not reliable. Scores for the nodes may be totaled and ranked in order to determine the most reliable nodes for selection as voting nodes.

Alternatively and/or additionally, a record may be maintained of nodes that have problems and/or are to be or not to be trusted. Such a record of reliable and/or unreliable nodes may be used to determine the most reliable nodes and/or modify the results of another procedure used to determine the most reliable nodes.

In yet other examples, reliability of nodes may instead be evaluated based on the ability of nodes to respond to requests to process transactions. If a node is overloaded and does not timely respond to requests, the node may be indicated as unreliable. That node may then not be selected as a voting node based on the node's inability to respond timely to transaction processing requests. Various configurations are possible and contemplated without departing from the scope of the present disclosure.

Next, the flow proceeds to 1330 where the most reliable nodes are used as the voting nodes. The flow then proceeds to 1340 where it is determined whether or not to reevaluate the voting nodes. If so, the flow returns to 1320 where the most reliable nodes are again determined. Otherwise, the flow returns to 1330 where the previously determined most reliable nodes are used to process additional transactions for the blockchain network.

Although the example method 1300 is illustrated and described as including particular operations performed in a particular order, it is understood that this is an example. In various implementations, various orders of the same, similar, and/or different operations may be performed without departing from the scope of the present disclosure.

For example, 1340 is illustrated and described as reevaluating voting nodes. However, in some examples, different nodes may be selected as voting nodes without reevaluating reliability of any nodes. Various configurations are possible and contemplated without departing from the scope of the present disclosure.

In various examples, this example method 1300 may be implemented as a group of interrelated software modules or components that perform various functions discussed herein. These software modules or components may be executed by one or more computing devices, such as one or more of the ordering node 802A or the peer nodes 802B of FIG. 8A.

In various embodiments, a system for dynamically assigning voting nodes to improve transaction speed in a blockchain network may include at least one non-transitory storage medium that stores instructions and at least one processor. The at least one processor may execute the instructions to open a first segment for a blockchain, select a first voting node group from a set of peer nodes, use the first voting node group to process transactions for the first segment, open a second segment for the blockchain wherein the second segment is associated with a different portion of the blockchain than the first segment, select a second voting node group from the set of peer nodes, and use the second voting node group to process transactions for the second segment.

In some examples, the at least one processor may select the first voting node group randomly. In other examples, the at least one processor may select the first voting node group in a round-robin fashion. In still other examples, the at least one processor may select the first voting node group based on which of the set of peer nodes are least busy. In yet other examples, the at least one processor may select the first voting node group based on which of the set of peer nodes are most reliable. In some implementations of such examples, the at least one processor may determine which of the set of peer nodes are most reliable by evaluating prior voting records in the blockchain.

In numerous examples, the at least one processor may open a third segment for the blockchain, select a third voting node group from the set of peer nodes, and use the third voting node group to process transactions for the third segment. The third segment may be associated with a different portion of the blockchain than the first segment and the second segment.

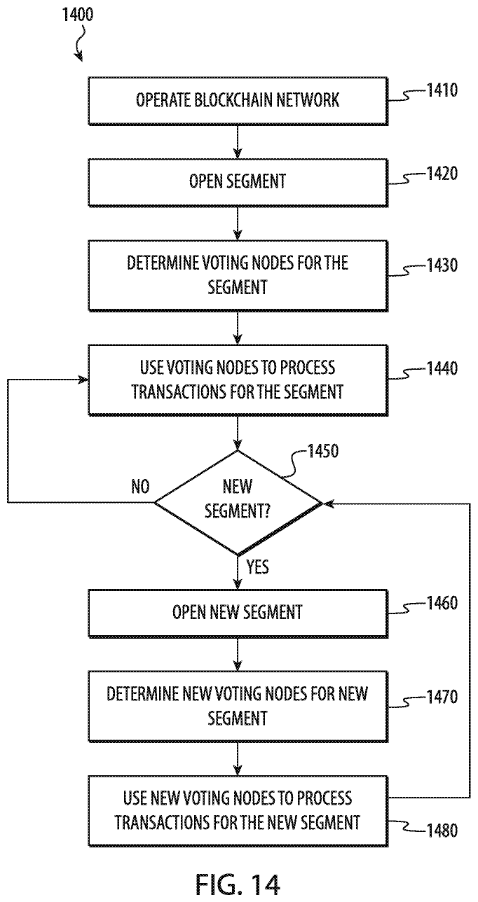

In various embodiments, a blockchain network may use segments. The blockchain network may create or open a sequence of segments corresponding to different portions of a blockchain. The blockchain network may interact with a respective segment corresponding to the appropriate portion of the blockchain. In such an example, voting nodes may be selected for each segment. In some implementations of this example, the same number of voting nodes may be selected for each segment. Various configurations are possible and contemplated without departing from the scope of the present disclosure. For example, FIG. 14 depicts a flow chart illustrating a sixth example method 1400 for dynamically assigning voting nodes in a blockchain network. This method 1400 may be performed by the system of FIGS. 8A-8C.

At 1410, a blockchain network may be operated. The blockchain network may be a blockchain network that uses segments. The flow then proceeds to 1420 where a segment is opened or created (e.g., a first segment). Next, the flow proceeds to 1430 where voting nodes (e.g., first voting nodes) are determined or otherwise selected or assigned for the segment. The flow then proceeds to 1440 where the determined voting nodes are used to process transactions for the segment.

Next, the flow proceeds to 1450 where it is determined whether or not to create a new segment. If not, the flow returns to 1440 where the determined voting nodes are used to process transactions for the segment. Otherwise, the flow proceeds to 1460.

At 1460, a new segment is opened. The flow then proceeds to 1470 where new voting nodes (e.g., second voting nodes) are determined for the new segment (e.g., a second segment). Next, the flow proceeds to 1480 where the newly determined voting nodes are used to process transactions for the new segment.

Next, the flow returns to 1450 where it is determined whether or not to create another new segment. If not, the flow returns to 1440 where the second voting nodes continue to be used to process transactions for the second segment. Otherwise, the flow returns to 1460 where another new segment (e.g., a third segment) is opened.

Any number of segments may be opened. Similarly, any number of voting nodes may be determined. 1450-1480 may repeat any number of times without departing from the scope of the present disclosure.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 is illustrated and described as opening segments and determining voting nodes for that segment as separate, linearly performed operations. However, in various examples, these operations may be performed simultaneously, substantially simultaneously, in parallel, and so on. Various configurations are possible and contemplated without departing from the present disclosure.

In various examples, this example method 1400 may be implemented as a group of interrelated software modules or components that perform various functions discussed herein. These software modules or components may be executed by one or more computing devices, such as one or more of the ordering node 802A or the peer nodes 802B of FIG. 8A.

In some embodiments, a system for dynamically assigning voting nodes to improve transaction speed in a blockchain network may include at least one non-transitory storage medium that stores instructions and at least one processor. The at least one processor may execute the instructions to select a first voting node group from a set of peer nodes; use the first voting node group to process transactions for a blockchain; upon occurrence of an event, select a second voting node group from the set of peer nodes; and use the second voting node group to process transactions for the blockchain.

In various examples, a peer node may be in both the first voting node group and the second voting node group. In other examples, the first voting node group and the second voting node group may have no overlapping peer nodes.

In some examples, the event may be creation of a new segment, elapse of a time period, or a transaction limit being reached. In numerous examples, the first voting node group may have a same number of voting nodes as the second voting node group.

In various examples, the at least one processor selects the first voting node group by selecting a security leader node. In some cases of such examples, the at least one processor uses the security leader node to select voting nodes of a voting council.

In numerous embodiments, an electronic device for dynamically assigning voting nodes to improve transaction speed in a blockchain network may include at least one non-transitory storage medium that stores instructions and at least one processor. The at least one processor may execute the instructions to use a voting node group to process transactions for a segment of a blockchain; create a changed voting node group upon creation of a new segment of the blockchain, the changed voting node group having a same number of nodes as the voting node group; and use the changed voting node group to process transactions for the new segment.

In various examples, the at least one processor may create the changed voting node group by submitting a test transaction to a set of nodes and selecting the changed voting node group from the set of nodes that respond fastest to the test transaction. In other examples, the at least one processor may create the changed voting node group by selecting the changed voting node group from a set of nodes that have the shortest network communication times. In still other examples, the at least one processor may create the changed voting node group by selecting the changed voting node group from a set of nodes that have the lowest resource loads. In yet other examples, the at least one processor may create the changed voting node group by excluding particular nodes. In additional examples, the at least one processor may create the changed voting node group by selecting nodes based on how the nodes processed prior transactions.

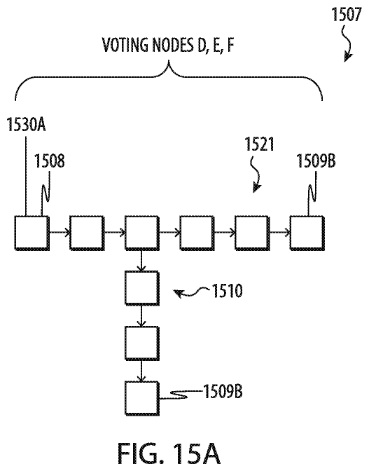

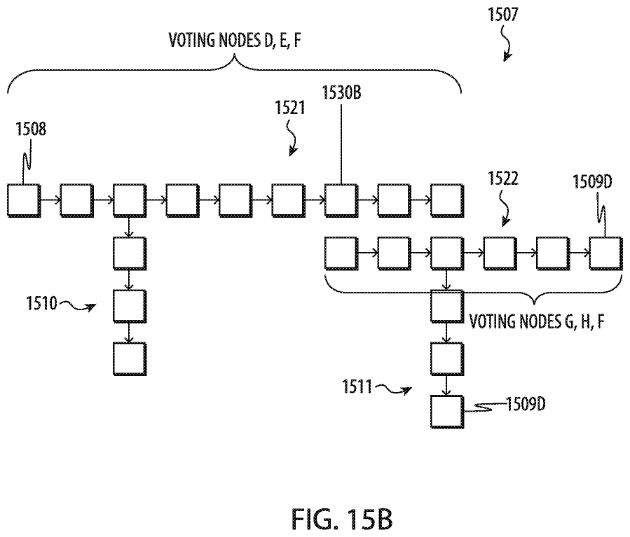

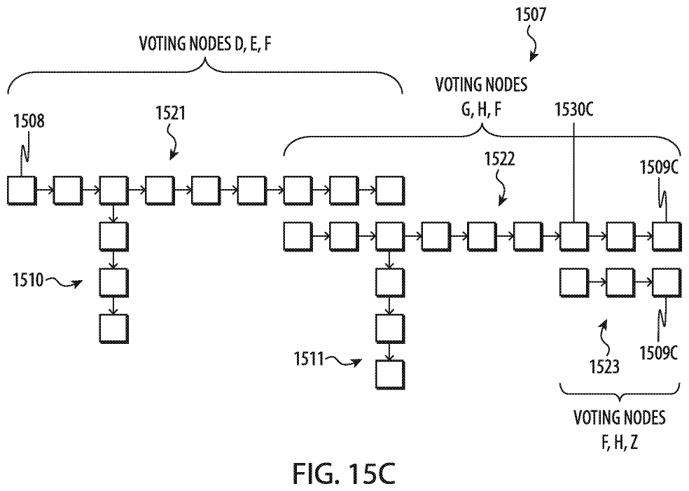

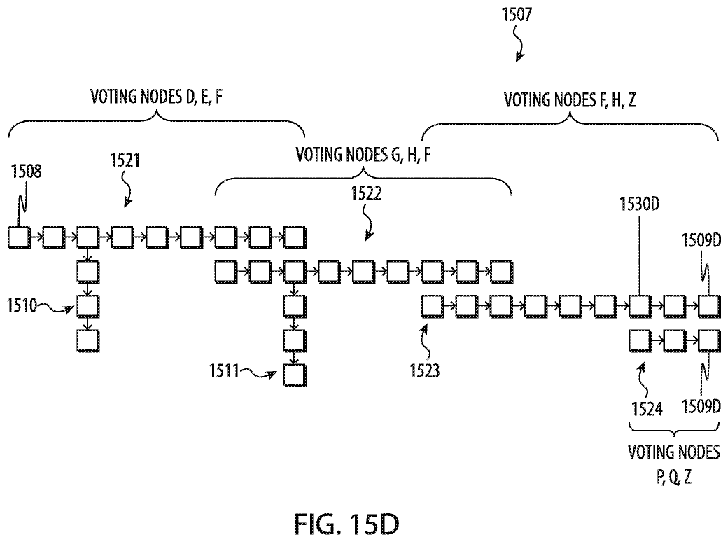

FIGS. 15A-15D depict an example of blockchain network operation that may be performed using the method 1400. It is understood that this is an example and is not intended to be limiting.

FIG. 15C depicts the blockchain of FIG. 15B after the blockchain network created a third segment with different associated third assigned voting nodes at a third time.

FIG. 15D depicts the blockchain of FIG. 15C after the blockchain network created a fourth segment with different associated fourth assigned voting nodes at a fourth time.

For example, FIG. 15A depicts an example blockchain 1507 including first segment 1521 with associated first assigned voting nodes created or opened at a first time 1530A by a blockchain network, such as the hyperledger fabric blockchain network 801 of FIGS. 8A-8C. As shown, the blockchain 1507 includes a genesis block 1508. The genesis block 1508 is linked to a number of other blocks. As also shown, nodes D, E, and F have been selected as voting nodes for the first segment 1521.

FIG. 15B depicts the blockchain 1507 of FIG. 15A after the blockchain network created or opened a second segment 1522 with different associated second assigned voting nodes at a second time 1530B. As shown, nodes G, H, and F have been selected as voting nodes for the second segment 1522. As also shown, the second segment 1522 overlaps the first segment 1521.

FIG. 15C depicts the blockchain 1507 of FIG. 15B after the blockchain network created or opened a third segment 1523 with still different associated third assigned voting nodes at a third time 1530C and archived or closed the first segment 1521. The first segment 1521 may have been closed or archived at the third time 1530C or another time. As shown, nodes F, H, and Z have been selected as voting nodes for the third segment 1523. As also shown, the third segment 1523 overlaps the second segment 1522.

FIG. 15D depicts the blockchain 1507 of FIG. 15C after the blockchain network created or opened a fourth segment 1524 with yet different associated fourth assigned voting nodes at a fourth time 1530D and archived the second segment 1522. The second segment 1522 may have been closed or archived at the fourth time 1530D or another time. As shown, nodes P, Q, and Z have been selected as voting nodes for the fourth segment 1524. As also shown, the fourth segment 1524 overlaps the third segment 1523.

In this example, the same number of voting nodes have been selected for the first segment 1521, the second segment 1522, the third segment 1523, and the fourth segment 1524. However, it is understood that this is an example. In various implementations, different numbers of voting nodes may be selected without departing from the scope of the present disclosure.

Further, in this example, the node F is selected as a voting node for both the first segment 1521 and the second segment 1522. However, it is understood that this is an example. In various implementations, the same node may not be again used as a voting node and/or not for sequential segments, overlapping segments, and so on. Various arrangements are possible and contemplated without departing from the scope of the present disclosure.

As illustrated, the first segment 1521, the second segment 1522, the third segment 1523, and the fourth segment 1524 correspond to sequential, overlapping portions of the blockchain 1507. However, is it understood that this is an example. Other arrangements are possible and contemplated without departing from the scope of the present disclosure.

The above illustrates and describes particular examples of assigning dynamic voting nodes. However, it is understood that these are examples. In various implementations, other configurations may be implemented without departing from the scope of the present disclosure.

For example, a blockchain network may use voting councils. A voting council may be a set of nodes that include a security leader and voting nodes. Voting councils may be generated and/or disbanded at various times or upon the occurrence of various conditions (such as any of the times and/or conditions described above with respect to dynamic assignments of voting nodes above). This may ensure that block verification may occur within a set amount of time, such as ten minutes.

In some implementations, validity of a voting council may be transient based on a certain number of transactions or a time limit. For example, the voting council may expire if either the time limit expires, or if the transaction limit is reached or exceeded.

In various implementations, a blockchain network may consist of available nodes and voting council nodes made up of a security leader node and voting nodes. A leader node may be selected from a leaderboard (list of available leader nodes which may be random, ranked according to available resources and/or any other criteria mentioned above for ranking nodes for voting node selection, and so on) by free nodes. The leader node may select additional free nodes as voting nodes. The leader node may give the voting nodes a certification with a transaction limit and/or a time limit of the voting council. The voting council and/or the voting nodes may then verify transactions. Transactions verified by the voting council and/or the voting nodes may be added to the blockchain. In some implementations, the last transaction of a voting council may be to add its entire chain as a superblock to the blockchain. When the council certificate expires due to time elapsed, transaction count exceeding the limit, and so on, the voting council may be disbanded. A new leader node and/or voting council may then be selected.

The leaderboard may be maintained and/or updated while the voting council operated, such as by free nodes. This updated leaderboard may be used to select the new leader for the new voting council.

The leader node may be a security leader. A security leader may be a node that takes the role of a security server for a voting council as well as determining additional voting nodes that vote on consensus for adding a block to the blockchain. The security leader may create certificates that are valid for a certain amount of time, a transaction limit for the voting council, and so on.

A voting node may be a node that is on the voting council but is not the security leader. Voting nodes may work on verifying the transactions that are assigned to the voting council.

A free node may be an available node that is not part of a voting council. Free nodes may maintain a leaderboard or pool from which security leaders may be selected for establishing a new voting council. Voting nodes from councils may be selected from this leaderboard.

A leaderboard may be a list, pool, or other structure from which security leader, voting nodes, and/or voting councils may be selected. In some implementations, the leaderboard may be based on a specific node's previous role of authority in the blockchain, central processing utilization percentage, and/or any other factor (such as those discussed above with respect to selection of voting nodes.

Weighted random functions may be used for maintaining the leaderboard and/or selecting nodes from the leaderboard. This may ensure randomness. This randomness may make it more difficult for attackers to target nodes the attackers believe will become security leaders or voting nodes.

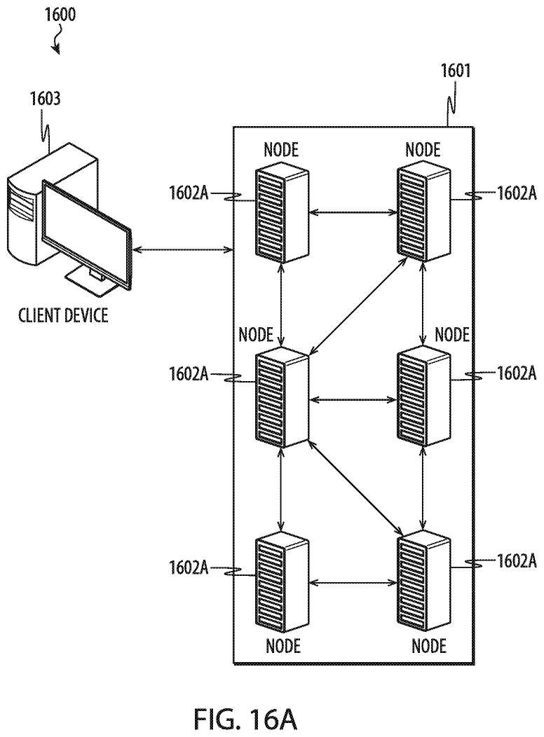

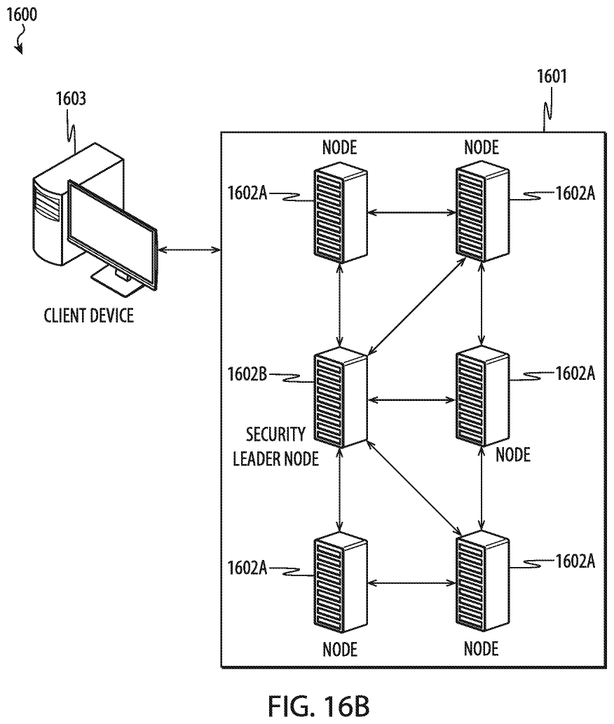

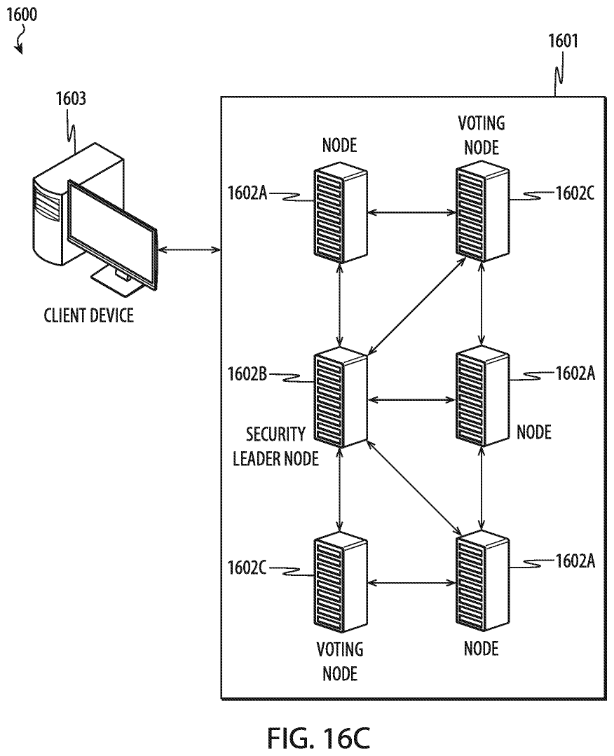

By way of illustration, FIG. 16A depicts a second example of a blockchain network system 1600 that dynamically assigns voting nodes. The blockchain network system 1600 may include a blockchain network 1601 and one or more client devices 1603. The blockchain network 1601 may include a group of nodes 1602A.

The nodes 1602A may each be able to operate as free nodes, security leader nodes, voting nodes, and so on. The blockchain network 1601 may select one or more of the nodes 1602A as a security leader node 1602B, as illustrated in FIG. 16B. As described above, the security leader node 1602B may be selected using a leaderboard maintained by the nodes 1602A.

The security leader node 1602B may then select the voting nodes 1602C, as illustrated in FIG. 16C. A voting council may be made up of the security leader node 1602B and voting nodes 1602C. As described above, the voting council may verify transactions, add verified transactions for the blockchain, and eventually disband.

During operation of the voting council, the nodes 1602A may maintain the leaderboard. The leaderboard may be used to select a new security leader node 1602B and the process may repeat.

In various implementations, the blockchain network system 1600 may use segments as illustrated and described above. In some implementations, different voting councils may be used for different segments. Various configurations may be possible without departing from the scope of the present disclosure.

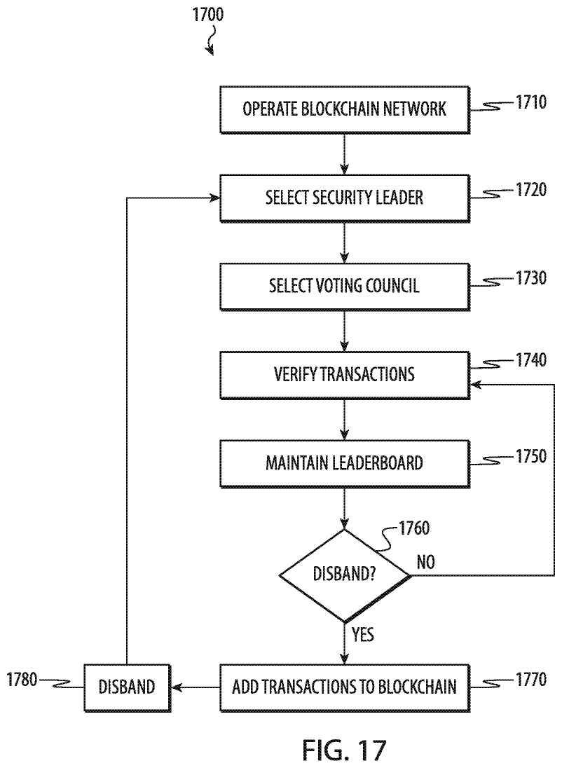

FIG. 17 depicts a flow chart illustrating a seventh example method 1700 for dynamically assigning voting nodes in a blockchain network. This method may be performed by the system 1600 of FIGS. 16A-16C.

At 1710, a blockchain network may be operated. The flow then proceeds to 1720 where a security leader node may be selected. The security leader node may be selected using a leaderboard maintained by free nodes. Next, the flow proceeds to 1730 where the security leader node may select the voting nodes of the voting council. The flow then proceeds to 1740 where the voting council verifies transactions for the blockchain. Next, the flow proceeds to 1750 where the free nodes maintain the leaderboard.

Next, the flow proceeds to 1760 where it is determined whether or not to disband the voting council. The decision to disband may be based on a time elapsed, a transaction limit being reached or exceeded, and so on (such as occurrence of any of the events for assigning new voting nodes discussed above). If not, the flow returns to 1740 where the voting council continues verifying transactions. Otherwise, the flow proceeds to 1770.

At 1770, the transactions verified by the voting council are added to the blockchain. The flow then proceeds to 1780 where the voting council is disbanded before the flow returns to 1720 and a new security leader node is selected.

Any number of voting councils may be created. 1720-1780 may repeat any number of times without departing from the scope of the present disclosure.

Although the example method 1700 is illustrated and described as including particular operations performed in a particular order, it is understood that this is an example. In various implementations, various orders of the same, similar, and/or different operations may be performed without departing from the scope of the present disclosure.

For example, the method 1700 is illustrated and described as adding the transactions verified by a voting council to the blockchain after determining to disband the voting council. However, in various implementations, transactions verified by a voting council may be added to the blockchain before a determination is made to disband the voting council. Various configurations are possible and contemplated without departing from the present disclosure.

In various examples, this example method 1700 may be implemented as a group of interrelated software modules or components that perform various functions discussed herein. These software modules or components may be executed by one or more computing devices, such as one or more of the nodes 1602A of FIG. 16A, the security leader node 1602B of FIGS. 16B-C, and/or the voting nodes 1602C of FIG. 16C.

In numerous examples, voting councils may use branching for write efficiency. Branches may be created whenever more than one voting council has come into existence. When a blockchain branches, multiple sub portions may come into existence. These sub portions may be concurrently parsed in order to verify the validity of a transaction. As such, branching by bank or some other grouping that may be consistent for the length of the branch may be used.

Such branching may be temporary and may only exist during the life of a voting council. Reconciliation may later be performed, which may remove one or more of the branches.

As described above, a branched blockchain may eventually be reconciled back into a single line. For example, superblock reconciliation may be used. In superblock reconciliation, the last act of a voting council may be adding all transactions verified by the voting council to the blockchain as a superblock. Reconciliation in this manner may cause these branches to never be added to the blockchain.

In some examples, a reconciliation node may be used. A reconciliation node may take two blocks from separate branches and consolidate them into a single block. This may allow subsequent blocks to be consolidated into a single line. This approach may not require additional resources for reconciliation. However, this approach may increase read times and/or parsing times of the blockchain, particularly if many branches are formed.

Full reconciliation may recombine the blocks from created branches into a single line using a voting council to add the branches into the existing pre-branched line of the blockchain. However, a large number of transactions may consume a significant amount of time for the reconciliation voting council. As the voting council may not be able to change during reconciliation, this amount of time may leave the reconciliation voting council more open to attack than voting councils that may change more rapidly.

Superblock reconciliation may involve each voting council adding all blocks verified by the voting council (the “superblock”) to the blockchain as the last act of the voting council. This may eliminate reconciliation while maintaining the blockchain. Branches in the blockchain in such an implementation may be temporary and may only exist in the voting council. However, superblocks may inherently not be time organized due to blocks being locked into superblocks.

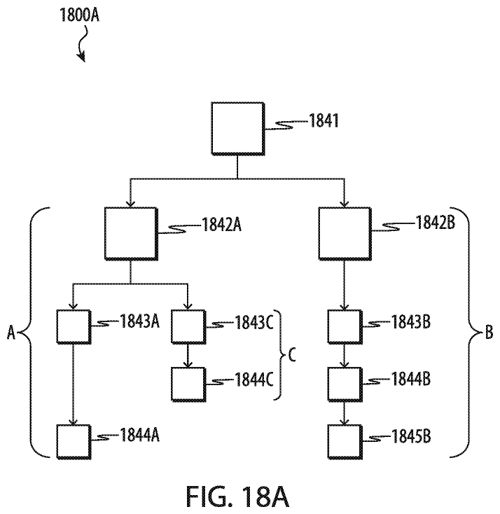

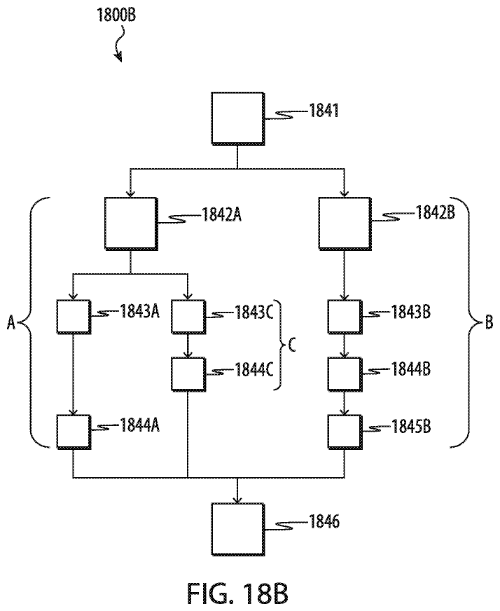

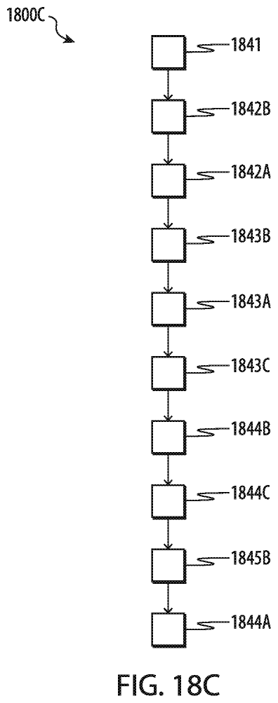

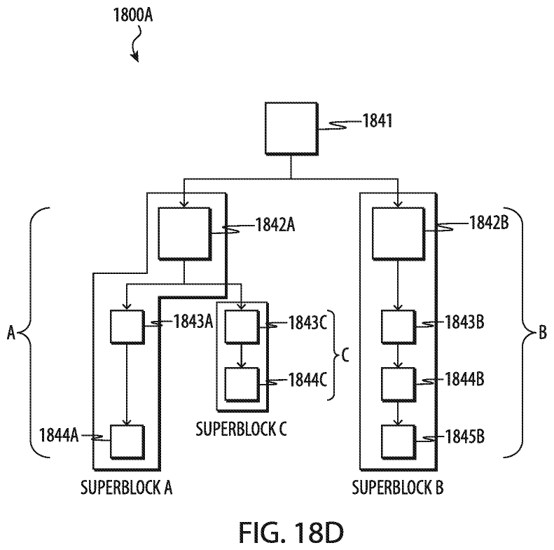

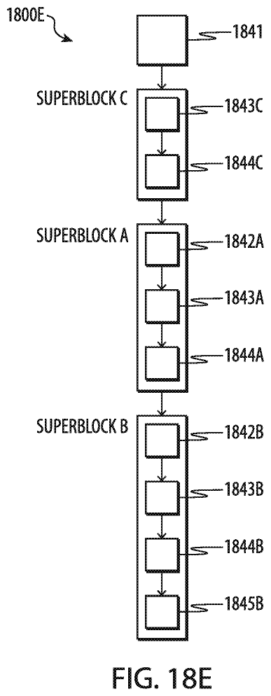

FIG. 18A depicts an example branched blockchain 1800A that may be created by multiple voting councils A, B, and C. As shown, the blockchain 1800A included block 1841 before the voting council A verified blocks 1842A, 1843A, and 1844A; the voting council B verified blocks 1842B, 1843B, 1844B, and 1845B; and the voting council C verified blocks 1843C and 1844C.

FIG. 18B depicts a first example of a reconciled version of the example branched blockchain 1800B that used a reconciliation node 1846. The reconciliation node 1846 connects the blocks verified by the voting nodes A, B, and C.

FIG. 18C depicts a second example of a reconciled version of the example branched blockchain 1800C that used a reconciliation voting council. As shown, the reconciliation voting council recombined the blocks 1841, 1842B, 1842A, 1843B, 1843A, 1843C, 1844B, 1844C, 1845B, and 1844A from the voting councils A, B, and C. The reconciliation voting council recombined the blocks 1841, 1842B, 1842A, 1843B, 1843A, 1843C, 1844B, 1844C, 1845B, and 1844A in order of respective time.

FIG. 18D depicts the example branched blockchain 1800A of FIG. 18A with superblocks A, B, and C indicated. As shown, blocks 1842A, 1843A, and 1844A are part of superblock A. Similarly, blocks 1843C and 1844C are part of superblock C and blocks 1842B, 1843B, 1844B, and 1845B are part of superblock B. FIG. 18E depicts a third example of a reconciled version of the example branched blockchain 1800E that used superblock reconciliation. As shown, the third example of a reconciled version of the example branched blockchain 1800E includes the line of block 1841, superblock C, superblock A, and superblock B.

The above illustrates and describes a number of embodiments. In various implementations, various features of these embodiments may be combined. Description of techniques with respect to one embodiment does not imply that they may not be used in implementations with other described embodiments. Various configurations are possible and contemplated without departing from the scope of the present disclosure.

As described above and illustrated in the accompanying figures, the present disclosure relates to blockchain networks that dynamically assign voting nodes for faster transaction speed. A first group of nodes are determined to be used as voting nodes for a blockchain network. The first group of voting nodes are used to process transactions for the blockchain network. At a point during operation of the blockchain network, a determination is made to re-determine voting nodes. A second group of nodes are determined to be used as the voting nodes for the blockchain network. The second group is then used to process transactions for the blockchain network. In this way, faster transaction speed may be obtained. This may result from ameliorating issues that cause delays in the voting nodes to come to a consensus on transactions. As the voting nodes may be changed or reassigned during blockchain operation, transaction processing will not be delayed by slowed network communications to a particular voting node, overloaded resources of a particular voting node, and so on. Faster transaction speeds improve the operation of the devices in the blockchain network, resulting in a faster and more efficient blockchain network that can support real time commercial application requirements.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for dynamically assigning voting nodes to improve transaction speed in a blockchain network, comprising:
at least one non-transitory storage medium that stores instructions; and
at least one processor that executes the instructions to:
open a first segment for a blockchain;
select a first voting node group from a set of peer nodes;
use the first voting node group to process transactions for the first segment;
open a second segment for the blockchain wherein the second segment is associated with a different portion of the blockchain than the first segment;
select a second voting node group from the set of peer nodes; and
use the second voting node group to process transactions for the second segment.

2. The system of claim 1, wherein the at least one processor selects the first voting node group randomly.

3. The system of claim 1, wherein the at least one processor selects the first voting node group in a round-robin fashion.

4. The system of claim 1, wherein the at least one processor selects the first voting node group based on which of the set of peer nodes are least busy.

5. The system of claim 1, wherein the at least one processor selects the first voting node group based on which of the set of peer nodes are most reliable.

6. The system of claim 5, wherein the at least one processor determines which of the set of peer nodes are most reliable by evaluating prior voting records in the blockchain.

7. The system of claim 1, wherein the at least one processor:
opens a third segment for the blockchain wherein the third segment is associated with a different portion of the blockchain than the first segment and the second segment;
selects a third voting node group from the set of peer nodes; and
uses the third voting node group to process transactions for the third segment.

8. A system for dynamically assigning voting nodes to improve transaction speed in a blockchain network, comprising:
at least one non-transitory storage medium that stores instructions; and
at least one processor that executes the instructions to:
select a first voting node group from a set of peer nodes;
use the first voting node group to process transactions for a blockchain;
upon occurrence of an event, select a second voting node group from the set of the peer nodes; and
use the second voting node group to process transactions for the blockchain.

9. The system of claim 8, wherein a peer node is in both the first voting node group and the second voting node group.

10. The system of claim 8, wherein the first voting node group and the second voting node group have no overlapping peer nodes.

11. The system of claim 8, wherein the event is:
creation of a new segment;
elapse of a time period; or
a transaction limit being reached.

12. The system of claim 8, wherein the first voting node group has a same number of voting nodes as the second voting node group.

13. The system of claim 8, wherein the at least one processor selects the first voting node group by selecting a security leader node.

14. The system of claim 13, wherein the at least one processor uses the security leader node to select voting nodes of a voting council.

15. An electronic device for dynamically assigning voting nodes to improve transaction speed in a blockchain network, comprising:
at least one non-transitory storage medium that stores instructions; and
at least one processor that executes the instructions to:
use a voting node group to process transactions for a segment of a blockchain;
create a changed voting node group upon opening a new segment of the blockchain, the changed voting node group having a same number of nodes as the voting node group; and
use the changed voting node group to process transactions for the new segment.

16. The electronic device of claim 15, wherein the at least one processor creates the changed voting node group by:
submitting a test transaction to a set of nodes; and
selecting the changed voting node group from the set of nodes that respond fastest to the test transaction.

17. The electronic device of claim 15, wherein the at least one processor creates the changed voting node group by selecting the changed voting node group from a set of nodes that have shortest network communication times.

18. The electronic device of claim 15, wherein the at least one processor creates the changed voting node group by selecting the changed voting node group from a set of nodes that have lowest resource loads.

19. The electronic device of claim 15, wherein the at least one processor creates the changed voting node group by excluding particular nodes.

20. The electronic device of claim 15, wherein the at least one processor creates the changed voting node group by selecting nodes based on how the nodes processed prior transactions.
